(19) United States
(12) Patent Application Publication
(10) Pub. No.: US 2026/0339757 A1
(43) Pub. Date: Oct. 29, 2026

(54) ARTIFICIAL INTELLIGENCE AGENT REASONING SHARING DURING INTER-AGENT COMMUNICATIONS

(71) Applicant: Salesforce, Inc., San Francisco, CA (US)

(72) Inventors: Bharath Cheluvaraju, Bangalore (IN); Rajdeep Dua, Hyderabad (IN)

(21) Appl. No.: 19/236,761

(22) Filed: Jun. 12, 2025

(30) Foreign Application Priority Data
Apr. 28, 2025 (IN) 202541040742

(51) Int. Cl. G06F 9/54

(52) U.S. Cl. CPC G06F 9/54

(57) ABSTRACT

A first agent of a multi-agent system may obtain an indication of a task for completion by multi-agent system. The first agent may output a message to a second agent indicating a sub-task of the task and a goal condition. The second agent may generate and output, based on an event, a report in accordance with an inter-agent reporting configuration. The report may include intermediate steps associated with execution of the sub-task and may be in accordance with a detail level. The first agent may calculate a deviation metric to quantify a deviation between the goal condition and at least one intermediate step. The first agent then output a correction message based on the deviation metric exceeding a threshold. Further, the first agent may obtain, from the second agent, an indication of a result of the sub-task and then may output an indication of a result of the task accordingly.

### CROSS REFERENCE

The present Application for Patent claims the benefit of India Provisional Patent Application No. 202541040742 by Cheluvaraju et al., entitled “ARTIFICIAL INTELLIGENCE AGENT REASONING SHARING DURING INTER-AGENT COMMUNICATIONS,” filed Apr. 28, 2025, assigned to the assignee hereof, and expressly incorporated by reference in its entirety herein.

### FIELD OF TECHNOLOGY

The present disclosure relates generally to database systems and data processing, and more specifically to artificial intelligence (AI) agent reasoning sharing during inter-agent communications.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some examples, the cloud platform or another type of platform may support multiple agents (e.g., artificial intelligence (AI) agents) that coordinate and communicate with each other in a multi-agent system. In some examples of a multi-agent system, an orchestrator agent may be utilized to coordinate and delegate tasks to other agents of the multi-agent system. However, AI agents within the multi-agent system may operate in relative isolation with respect to internal reasoning processes. For example, while agents may exchange task outputs, an AI agent may refrain from sharing the process of how an AI agent generates a task output, which may result in a lack of transparency between AI agents. In some cases, the lack of transparency may result in an orchestrator agent being unable to effectively identify and correct flawed reasonings before it results in incorrect outcomes that have to be corrected, thus causing an increase in latency and processing resource consumption. Further, errors or deviations in AI agent reasonings may propagate through a system without early detection, thus reducing the effectiveness, reliability, and accuracy of the multi-agent system.

### BRIEF DESCRIPTION OF THE DRAWINGS

FIG. 1 illustrates an example of a system that supports artificial intelligence (AI) agent reasoning sharing during inter-agent communications in accordance with aspects of the present disclosure.

FIGS. 2 and 3 show an example of a multi-agent system that supports AI agent reasoning sharing during inter-agent communications in accordance with aspects of the present disclosure.

FIG. 4 shows an example of a process flow that supports AI agent reasoning sharing during inter-agent communications in accordance with aspects of the present disclosure.

FIG. 5 shows an example of a flowchart that supports AI agent reasoning sharing during inter-agent communications in accordance with aspects of the present disclosure.

FIG. 6 shows a block diagram of an apparatus that supports AI agent reasoning sharing during inter-agent communications in accordance with aspects of the present disclosure.

FIG. 7 shows a block diagram of an inter-agent coordination module that supports AI agent reasoning sharing during inter-agent communications in accordance with aspects of the present disclosure.

FIG. 8 shows a diagram of a system including a device that supports AI agent reasoning sharing during inter-agent communications in accordance with aspects of the present disclosure.

FIG. 9 shows a block diagram of an apparatus that supports AI agent reasoning sharing during inter-agent communications in accordance with aspects of the present disclosure.

FIG. 10 shows a block diagram of a reporting module that supports AI agent reasoning sharing during inter-agent communications in accordance with aspects of the present disclosure.

FIG. 11 shows a diagram of a system including a device that supports AI agent reasoning sharing during inter-agent communications in accordance with aspects of the present disclosure.

FIGS. 12 and 13 show flowcharts illustrating methods that support AI agent reasoning sharing during inter-agent communications in accordance with aspects of the present disclosure.

### DETAILED DESCRIPTION

Artificial intelligence (AI) agents, (e.g., large language models (LLM) agents), may be examples of autonomous entities configured to perform specific tasks by processing and analyzing data. In some examples, agents can operate independently or as part of a multi-agent system, where multiple AI agents collaborate to achieve a common goal. In a multi-agent system, each agent may have specialized capabilities such that different agents may be utilized to execute different aspects of a complex task. In some examples, AI agents, such as LLM agents, may utilize one or more AI or machine learning (AI/ML) models to leverage advanced natural language processing capabilities to understand and generate human-like text (e.g., natural language text). Further, by integrating two or more AI agents into a multi-agent framework, users may be capable of having relatively complex tasks completed by the AI agents.

For example, a first AI agent that acts as an orchestrator for the multi-agent system may segment a task into one or more sub-tasks for different AI agents of the multi-agent system to execute. Further, the first AI agent may delegate the one or more sub-tasks to one or more AI agents of the multi-agent system based on capabilities of the one or more AI agents. Moreover, after each AI agent executes a respective sub-task, the first AI agent (e.g., the orchestrator agent) may obtain the sub-task results and synthesize the sub-task results to generate a result for task. However, each AI agent may refrain from sharing the reasonings and steps performed to generate the sub-task results which may result in the first AI agent being unable to correct the AI agents until after obtaining the result of the sub-tasks. For example, the first AI agent may refrain from indicating an overall goal that a sub-task is assisting to achieve, and the other AI agents may refrain from indicating a procedure performed to generate a result of a sub-task. Such lack of communication between AI agents may result in an increase in latency and consumption of computing resources due to AI agents being unable to be corrected until after completion of a task or sub-task.

In some examples, to support inter-agent task execution, a first AI agent (e.g., an LLM agent) may obtain an indication of a first task for completion by one or more AI agents of a multi-agent system. Further, the first task may be associated with one or more sub-tasks and a goal condition. The first AI agent may then delegate the one or more sub-tasks and output a first message to a second AI agent that indicates a first sub-task and the goal condition of the first task. In response, the second AI agent may execute the first sub-task and based on a triggering event, generate a report associated with the execution of the first sub-task at the second AI agent. In some cases, the report may include information associated with a detail level (e.g., a level of abstraction) that is based on an inter-agent reporting configuration and the second AI agent may output the report to the first AI agent in accordance with the inter-agent reporting configuration. Further, the report may be a reasoning log that includes an indication of one or more intermediate steps performed by the second AI agent during the execution of the first sub-task.

Based on obtaining the report, the first AI agent may calculate a deviation metric for at least one intermediate step to quantify a reasoning deviation between the goal condition and the at least one intermediate step. For example, the second AI agent may have performed the at least one intermediate step when executing the first sub-task which results in a deviation away from the goal condition of the first task. Further, the first AI agent may output a reasoning correction message to the second AI agent based on the deviation metric exceeding a threshold. The reasoning correction message may indicate the at least one intermediate step that is associated with the deviation metric such that the second AI agent can determine how to reevaluate the execution of the first sub-task to be in compliance with the goal condition of the first task. Further, after completing the execution of the first sub-task, the second AI agent may output a result of the first sub-task to the first AI agent and the first AI agent may output a result of the first task based on obtaining the result of the first sub-task of the first task. Therefore, based on receiving the report, in accordance with the techniques of the present disclosure, the first AI agent may be capable of correcting the reasoning (e.g., correcting the predictions and outputs) of the second AI agent during execution of the first sub-task which can reduce the latency of executing the first task. Moreover, implementing an inter-agent reporting configuration may ensure that the information of the report is in accordance with a connection between the first AI agent and the second AI agent, thus improving the security of sharing the reasonings of the second AI agent. Additionally, or alternatively, correcting the second AI agent during execution of the first sub-task rather than after the execution may reduce the quantity of computational resources consumed by the second AI agent by preventing the second AI agent from having to re-execute the full sub-task.

In some examples, to ensure that the second AI agent is capable of accurately performing the first sub-task, the first AI agent may indicate the goal condition and other sub-tasks being performed by other AI agents. For example, by providing the second AI agent with such information, the second AI agent may be capable of executing the first sub-task relatively more efficiently and accurately to ensure that the result of the first sub-task is both in accordance with the goal condition of the first task and can complement the other sub-tasks of the first task. Further, in some cases, the second AI agent may output the report based on a triggering event to ensure that the first AI agent has an opportunity to evaluate the execution of the first sub-task, and, if needed, provide a correction to the second AI agent prior to completing the execution of the first sub-task. For example, the second AI agent may be configured to output the report after an execution of each intermediate step, an execution of a set of intermediate steps, a request from the first AI agent, a low confidence score associated with an intermediate step, a resource conflict, a deviation detection, or any combination thereof. Therefore, by sharing the reasonings and reports, AI agents may be capable of executing tasks and sub-tasks relatively more accurate, efficient, and reliable task and sub-task due to the increased collaboration and information exchanged.

Further, when generating a report, the second AI agent may generate the report such that the information is in accordance with a detail level or abstraction level. For example, the report can include a summary of information associated with the execution of the first sub-task, a subset of the information associated with the execution of the first sub-task, or an indication of all the information associated with the execution of the first sub-task. The second AI agent may determine which detail level to include in the report based on an inter-agent reporting configuration between the first AI agent and the second AI agent that indicates the capabilities of the AI agents, the configuration of the AI agents, a relationship between the AI agents, or any combination thereof. Thus, the second AI agent may determine a level of information to include in a report based on the capability of both the first AI agent and the second AI agent, the configuration of both the first AI agent and the second AI agent, a relationship between the first AI agent and the second AI agent, or any combination thereof. Additionally, or alternatively, the first message from the first AI agent to the second AI agent indicating the first sub-task and the goal condition may also be in accordance with a detail level that is based on the inter-agent reporting configuration. Therefore, the first AI agent and the second AI agent may selectively determine a level of information to include in reports, such as reasoning log reports, to ensure that respective AI agent obtaining (e.g., receiving) a report is capable of evaluating the report and to provide an increase level of security between the AI agents.

Aspects of the disclosure are initially described in the context of an environment supporting an on-demand database service. Additional aspects of the disclosure are described in the context of a multi-agent system, a process flow, and a flow chart. Aspects of the disclosure are further illustrated by and described with reference to apparatus diagrams, system diagrams, and flowcharts that relate to AI agent reasoning sharing during inter-agent communications.

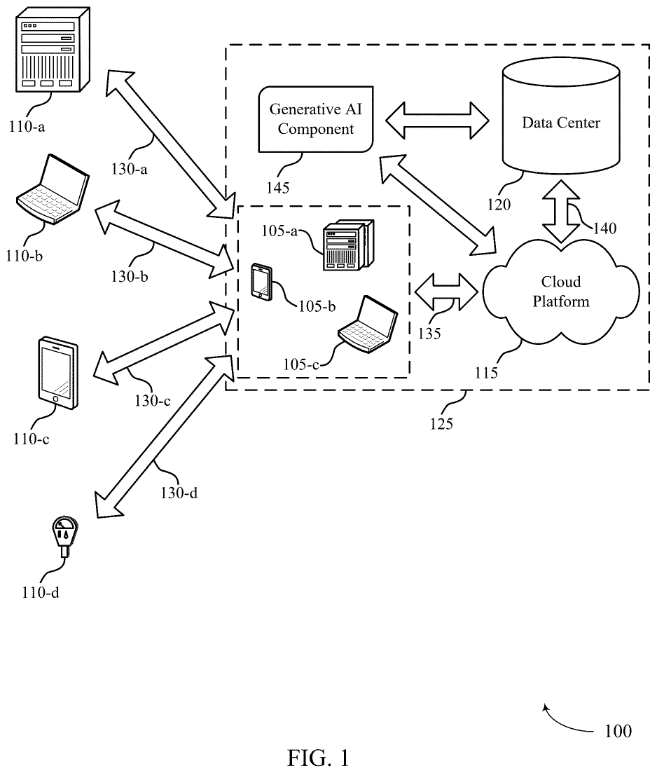

FIG. 1 illustrates an example of a system 100 for cloud computing that supports AI agent reasoning sharing during inter-agent communications in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative AI component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples of the system 100, agents (e.g., AI agents or LLM agents associated with the generative AI component 145) may operate within a multi-agent system. In some examples, AI agents may be controlled by or receive tasks from an AI agent that acts as an orchestrator agent. For example, an orchestrator agent may interact with a user that requests an action to be performed, and the orchestrator agent can delegate tasks or sub-tasks to multiple agents. However, within a multi-agent system, AI agents may operate in relative isolation regarding internal decision-making processes. Further, when delegating the tasks, the orchestrator agent may simply indicate a task for an AI agent to complete and may refrain from including any additional information. For example, if the task that an AI agent is delegated to complete is a sub-task, the AI agent may not receive any information about the overall task and goal that is being requested by the user. Such of transparency between AI agents may result in inefficiencies in multi-agent systems. For example, an AI agent that acts as an orchestrator agent may be incapable of sending correction messages or indications until after receiving a final result or output which may result in increases in latency and computational resource consumption for multi-agent system communications. Further, since the AI agents may be unaware of the procedures being performed or the decisions being made by other AI agents, the AI agents within the multi-agent system may be unable to work together effectively, identify additional collaborative techniques, build on the work of other AI agents, or any combination thereof. Therefore, multi-agent systems employed by or connected to the generative AI component 145 of the system 100 may be forced to rely on relatively costly trial-and-error approaches which can result in relatively high levels of computational resources consumption and large delays in task executions.

In accordance with the techniques of the present disclosure, the generative AI component 145 of the system 100 may support a framework that improves inter-agent communication by implementing structured sharing of internal reasoning processes. For example, when delegating tasks, an AI agent acting as an orchestrator agent may indicate an overall goal and plan of the task to the respective tasks. In some cases, if the task is a sub-task, the indication may include indications of other tasks being performed by other AI agents, an overall goal of the parent task, and how the result of the sub-task may be used. For example, a user may query an AI agent (e.g., the orchestrator agent of a multi-agent system associated with the generative AI component 145 of the system 100) to determine the fastest and most fuel efficient driving route from point A to point B and to indicate one or more stopping points to rest. After obtaining such query, the orchestrator agent may generate one or more sub-tasks from the task indicated in the query. For example, the orchestrator agent may generate a first sub-task for determining the fastest routes from point A to point B, a second sub-task for determining the fuel economy of various routes from point A to point B, and a third sub-task for determining one or more rest points between point A and point B.

The orchestrator agent may then delegate the sub-tasks to multiple different AI agents within the multi-agent system. For example, a first AI agent may obtain the first sub-task, a second AI agent may obtain the second sub-task, and a third AI agent may obtain the third sub-task. In the messages indicating which sub-task a respective AI agent is performing, in accordance with the techniques of the present disclosure, the orchestrator agent may indicate the overall goal of the task indicated via the query. For example, in the message to the third AI agent, the orchestrator agent may instruct third AI agent to find one or more resting points along the route from point A to point B and indicate that an overall goal is to find a fastest and most fuel efficient route. By providing the third AI agent with such information, the third AI agent may thus be capable of executing the respective sub-task to generate a result that is both in compliance with the goal of the third sub-task and the goal of the overall task, therefore enhancing the accuracy of the multi-agent system and preventing additional task executions which may increase the latency and resource consumption of the multi-agent system.

Further, during the execution of an AI agent, each respective AI agent may use one or more reasoning techniques to generate results or outputs. In accordance with the techniques of the present disclosure, each AI agent may generate a report (such as a reasoning log) to document intermediate steps, alternative hypotheses considered, specific justifications for choices or determinations made, confidence levels at each step, references to external resources consulted, or any combination thereof. The AI agents may then share the reports with the orchestrator agent based on event triggers such that if a respective AI agent is deviating from the goal of a respective sub-task or the overall goal of task, the orchestrator agent can transmit or send corrective messages prior to the completion of sub-task. Therefore, the orchestrator agent may be capable of preventing the respective AI agent from having to completely re-execute of the sub-task if the output is incorrect. Additionally, or alternatively, the techniques of the present disclosure may include the AI agents within the multi-agent system utilizing inter-agent reporting configurations (e.g., configurations indicating selective sharing protocols) that dynamically determine when information (such as reasoning logs) should be shared and at what level of detail, based on various triggering events such as confidence thresholds or detected deviations from expected patterns. In some examples, the level that detail should be shared at (e.g., the detail level indicated via the inter-agent reporting configurations) may be utilized to maintain system efficiency and protect sensitive information and to ensure that information is shared between agents at appropriate granularities based on agent capabilities, agent configurations, relationships between agents, or any combination thereof. Therefore, in accordance with the techniques of the present disclosure, the generative AI component 145 of the system 100 may assist in ensuring a balance between transparency and performance for multi-agent systems, while ensuring inter-agent reporting configuration compliance, to reduce the latency, resource consumption, and security concerns of multi-agent systems.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

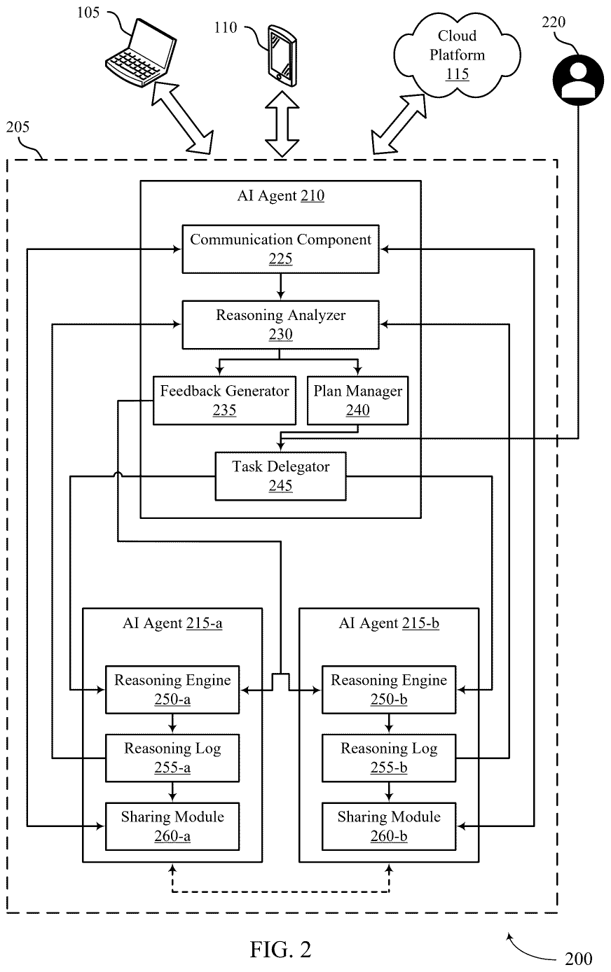

FIG. 2 shows an example of a multi-agent system 200 that supports AI agent reasoning sharing during inter-agent communications in accordance with aspects of the present disclosure. In some examples, the multi-agent system 200 may implement or be implemented by the system 100. For example, the multi-agent system 200 may include a subsystem 205 that can be associated with one or more contacts 110, one or more cloud clients 105, and a cloud platform 115, which may represent examples of corresponding devices described herein with reference to FIG. 1. Further, the subsystem 205 may be hosted locally at a contact 110, a cloud client 105, or both, or can be hosted within the cloud platform 115. The subsystem 205 may include an AI agent 210 and one or more AI agents 215 (e.g., an AI agent 215-a and an AI agent 215-b). In some examples, the subsystem 205 may illustrate the system where the AI agents of the multi-agent system 200 are hosted, configured, utilized, or any combination thereof.

In some examples, the multi-agent system 200 may illustrate a subsystem 205 that includes an AI agent 210, an AI agent 215-a, and an AI agent 215-b, that are part of the multi-agent system 200. In some cases, the AI agent 210 may act as an orchestrator agent. An orchestrator agent may act as a central coordinator within the multi-agent system 200, managing and delegating tasks to ensure that various AI agents (e.g., the one or more AI agents 215) work together effectively to achieve a common goal. When the AI agent 210 functions as the orchestrator agent, the AI agent 210 may control the AI agent 215-a and AI agent 215-b by assigning respective sub-tasks and monitoring the progress of the AI agent 215-a and AI agent 215-b.

In some cases, the AI agent 210, the AI agent 215-a, and the AI agent 215-b may operate in relative isolation with respect to internal reasonings. For example, while the AI agent 210, the AI agent 215-a, and the AI agent 215-b may exchange task outputs, the respective AI agents may refrain from sharing the process performed to arrive at or obtain the task output. In some cases, such isolation may result in inefficient orchestrations by the AI agent 210. For example, the AI agent 210 may lack the information associated with the reasonings for outputs from the AI agents 215 such that the AI agent 210 may be unable to identify and correct flawed or incorrect decision making before it leads to incorrect or inaccurate results. Thus, course corrections from the AI agent 210 may be relatively late resulting in wasted efforts. For example, if the result of a sub-task from the AI agent 215-a is incorrect and the AI agent 210 is unable to correct the AI agent 215-a earlier, the AI agent 215-a may have to re-execute the sub-task entirely resulting in a waste of time and computing resources.

Further, having the AI agents (e.g., the AI agent 210, the AI agent 215-a, and the AI agent 215-b) of the subsystem 205 in the multi-agent system 200 be isolated from each other may also result in reduced collaboration efficiency. For example, based on refraining from sharing reasonings or determination decisions, the AI agent 210, the AI agent 215-a, and the AI agent 215-b may be incapable of building on the reasonings or determination decisions to more effectively make determinations and identify potential synergies between the AI agent 210, the AI agent 215-a, and the AI agent 215-b. In some cases, the lack of information sharing may result in errors being propagated through the multi-agent system 200 that can result in relatively large computing resource consumptions. For example, the AI agent 215-a may generate an incorrect output to a sub-task due to flawed reasonings and such sub-task output may be utilized by various other AI agents 215. Thus, when the AI agent 210 synthesizes the sub-task outputs to generate a result or output for the overall task, the AI agent 210 may determine that the output is incorrect and may have to send a course correction message to each AI agent 215. For example, the AI agent 210 may be unable to determine which AI agent 215 generated an incorrect sub-task output that results in the overall task output being incorrect. Further, the AI agent 210 may then have to send course correction messages to each AI agent 215 instructing each AI agent 215 to re-execute the sub-task in accordance with the course correction message which may consume a relatively large quantity of resources.

Additionally, or alternatively, having each AI agent of the subsystem 205 in the multi-agent system 200 remain isolated may inhibit to overall understanding and trust of the multi-agent system 200. For example, since the reasonings of each AI agent is internal and not shared, auditing the multi-agent system 200 may be relatively difficult as there may be a lack of explainability behind actions. Further, it may be relatively difficult to trace agent decisions or determinations back to specific reasonings to understand why an AI agent made a respective decision or determination. For example, in some scenarios (e.g., in legal and healthcare use cases), understanding why an AI agent makes a decision or determination may be as important, or more important, than the actual decision or determination. Additionally, or alternatively, being unable to determine how AI agents in the multi-agent system 200 make decisions and determinations may limit the ability for users to debug the multi-agent system 200.

Moreover, such actions may limit the trust that users have in AI agents. Further, when reasonings remain isolated, AI agents may be unable to learn based on other AI agent mistakes and successes. For example, the AI agent 215-a may make a mistake on a task and receive a course correction from the AI agent 210 to mitigate the mistake in subsequent executions. However, if the AI agent 215-b is isolated from the AI agent 210 and the AI agent 215-a, the AI agent 215-b may make the same mistake causing additional resources to be wasted waiting for the AI agent 215-b to correct the mistake.

In accordance with the techniques of the present disclosure, to mitigate such issues and concerns, the AI agents of the multi-agent system 200 (e.g., the AI agent 210, the AI agent 215-a, and the AI agent 215-b) may implement a framework for sharing reasonings during inter-agent communications to improve the effectiveness, reliability, and accuracy of the multi-agent system 200. In some examples, the AI agent 210 may operate as an orchestrator agent in accordance with the techniques of the present disclosure and interact with a user 220 to execute a task from the user 220. For example, the user 220 may query the AI agent 210 with a task for execution by the subsystem 205 of the communications component 225. Additionally, or alternatively, another AI agent, platform, or service, may query the AI agent 210 with the task for execution by the subsystem 205. As an orchestrator agent, the AI agent 210 may be configured with a communications component 225, a reasoning analyzer 230, a feedback generator 235, a plan manager 240, and a task delegator 245.

In some cases, the task delegator 245 may interact with a user 220. For example, the task delegator may obtain (e.g., receive), from the user 220, an indication of a first task for completion by one or more AI agents of the multi-agent system 200 (e.g., the AI agent 215-a and the AI agent 215-b). In some other cases, the task delegator 245 may interact with another AI agent of the multi-agent system 200. Further, the first task may be associated with one or more sub-tasks and a goal condition. Moreover, based on obtaining the indication of the first task, the task delegator 245 of the AI agent 210 may generate the one or more sub-tasks of the first task and a goal condition for the one or more sub-task. The task delegator 245 may then assign respective sub-tasks to the AI agent 215-a and the AI agent 215-b. For example, the AI agent 210, via the task delegator 245, may output, to the AI agent 215-a, the AI agent 215-b, or both, a first message indicating a first sub-task of the one or more sub-tasks and an indication of the goal condition for the first task.

In some cases, the task delegator 245 may assign respective sub-tasks to the AI agent 215-a and the AI agent 215-b based on the capabilities of the AI agent 215-a and the AI agent 215-b, respectively. In some examples, the AI agent 215-a and the AI agent 215-b may be examples of two different AI agents 215 with different capabilities or can be examples of two versions of the same AI agent (e.g., the AI agent 215-a and the AI agent 215-b share the same capabilities). Moreover, it should be understood that while the multi-agent system 200 illustrated herein only depicts two AI agents 215 as receiving sub-tasks from the AI agent 210, there may be more than two or less than two AI agents 215 within the multi-agent system 200. In some examples, to assist the task delegator 245 in determining how to delegate or assign sub-tasks, the AI agent 210 may obtain, from an AI agent of the one or more AI agents of the multi-agent system 200 (e.g., the AI agent 215-a, the AI agent 215-b, or both), an indication of one or more capabilities of the AI agent, an indication of a configuration of the AI agent, or both. Therefore, the AI agent 210 may output the first message to the AI agent 215-a, the AI agent 215-b, or both, that indicates a respective sub-task (e.g., a first sub-task) and a goal condition of the overall task based on obtaining the indication of the one or more capabilities of the AI agent 215-a, the AI agent 215-b, or both and the one or more capabilities indicating that the respective AI agent 215 is capable of executing the respective sub-task.

The AI agent 215-a and the AI agent 215-b may be both be configured with a reasoning engine 250 (e.g., a reasoning engine 250-a for the AI agent 215-a and a reasoning engine 250-b for the AI agent 215-b), a reasoning log 255 (e.g., a reasoning log 255-a for the AI agent 215-a and a reasoning log 255-b for the AI agent 215-b), and a sharing module 260 (e.g., a sharing module 260-a for the AI agent 215-a, and a sharing module 260-b for the AI agent 215-b). In some examples, the reasoning engine 250 of a respective AI agent 215 may obtain a respective sub-task from the task delegator 245 of the AI agent 210. For example, the reasoning engine 250-a may obtain, from the task delegator 245, an indication of a first-sub task for the AI agent 215-a to execute and the reasoning engine 250-b may obtain, from the task delegator 245, an indication of a second sub-task for the AI agent 215-b to execute.

In some examples, the reasoning engine 250 may be configured to facilitate the execution of a respective sub-task for an AI agent 215. For example, the reasoning engine 250-a of the AI agent 215-a may obtain an indication of a sub-task and then evaluate the information of the sub-task such that the AI agent 215-a can execute the sub-task. In some cases, evaluating the information of the sub-task may include processing data and generating insights on how the sub-task should be executed. Further, execution of a sub-task by an AI agent 215 may include the reasoning engine 250 of the AI agent 215 generating hypotheses to determine one or more intermediate steps for the AI agent 215 to perform. In some cases, generating the hypotheses may include generating potential steps or sequence of steps (e.g., paths) that could be executed. For each step or sequence of steps, the reasoning engine 250 may also generate a justification and a confidence level. In some cases, the justification may indicate a reasoning for why the reasoning engine 250 considered the hypothesis, why the reasoning engine 250 selected a respective intermediate step, why the reasoning engine 250 rejected a respective intermediate step, or any combination thereof. Further, the confidence level may be an AI/ML metric that indicates a degree of certainty or reliability that the reasoning engine 250 has for a respective hypothesis. Additionally, or alternatively, the reasoning engine 250 may also indicate if any external sources were used to generate a hypothesis. For example, if the AI agent 215-a receives a sub-task to determine the fastest route from point A to point B, the reasoning engine 250 may indicate that a global positioning system (GPS) software external to the multi-agent system 200 is utilized to determine a route.

During the decision-making process, the reasoning engine 250 of the AI agent 215 may generate a reasoning log 255. In some examples, the reasoning log 255 may indicate the “inner monologue” performed by the reasoning engine 250 of an AI agent 215 to determine which steps to execute and perform. In some cases, the reasoning engine 250 may log the reasonings and decision-making process of the AI agent 215 in the reasoning log 255 within a decision-making process format such as a chain-of-thought (CoT) or a tree-of-thoughts (CoT) format. A CoT format of a reasoning log 255 may represent a linear sequence of intermediate steps executed by an AI agent 215 where each intermediate steps builds on the previous intermediate steps. A ToT format of a reasoning log 255 may illustrate the decision making process performed by a reasoning engine 250 of an AI agent 215 that is represented as a branching structure where multiple alternative paths are considered. For example, for a sub-task of finding a fastest route from point A to point B, a first branch indicated via the reasoning log 255 may indicate a consideration of a first route and a second branch indicated via the reasoning log 255 may indicate a consideration of a second route. Further, out of the branches indicated via the reasoning log 255, the reasoning log 255 may also indicate which branch and corresponding intermediate steps are selected for the AI agent 215 to execute. Thus, a reasoning log 255 indicating a ToT decision-making process of a reasoning engine 250 may indicate both the one or more intermediate steps performed by the AI agent 215 and the rejected alternative intermediate steps along with reasonings or justifications for both the intermediate steps and the rejected alternative intermediate steps.

During execution of a sub-task, in accordance with the techniques of the present disclosure, an AI agent 215 may output the reasoning log 255 to the AI agent 210 for evaluation and potential reasoning correction. In some cases, the AI agent 215 may output the reasoning log 255 in accordance with a triggering event. In some examples, a triggering event may be based on the end of a step, a low confidence score, a request, a deviation detection, a resource conflict, or any combination thereof. For example, for an end of step triggering event, after each intermediate step (e.g., either each intermediate step or each relatively significant intermediate step that may potentially impact subsequent intermediate steps), the AI agent 215 may report the reasoning log 255 to the AI agent 210. For a confidence score based trigger, an AI agent 215 may output the reasoning log 255 to the AI agent 210 based on a confidence score of an intermediate step or a hypothesis failing to satisfy a confidence score threshold. Further, the confidence score based trigger may be based on a confidence score associated with a latest intermediate step of one or more intermediate steps failing to satisfy the confidence score threshold, a quantity of intermediate steps failing to satisfy the confidence score threshold, or both.

Thus, the AI agent 210 may obtain, from the AI agent 215-a or the AI agent 215-b via a reasoning log 255-a, a reasoning log 255-b, or both (e.g., a first reasoning log), an indication of one or more alternative intermediate steps, an indication of one or more reasonings for the one or more intermediate steps taken by a respective AI agent 215, an indication of a confidence score for each of the one or more alternative intermediate steps, the one or more intermediate steps, or both, an indication of one or more sources associated with the one or more intermediate steps taken, or any combination thereof. For example, in some cases, when the AI agent 215-a is generating the reasoning log 255-a, the reasoning engine 250-a may use one or more sources to obtain information to determine a respective intermediate step, a respective alternative intermediate step, or both, and to determine a respective reasoning for selecting to perform the respective intermediate step and refraining from selecting to perform the respective alternative intermediate step. In some cases, the one or more sources may include one or more databases, one or more APIs, one or more websites, one or more external data sources, one or more CRMs, or any combination thereof. For example, to generate a respective intermediate step, a respective alternative intermediate step, or both, the AI agent 215-a may interact with a data source to obtain information associated with the sub-task delegated to the AI agent 215-a.

In another example, the AI agent 215-a, the AI agent 215-b, or both, may output a respective reasoning log 255 based on a request from the AI agent 210. For example, the AI agent 210 may output, to the AI agent 215-a, the AI agent 215-b, or both, a request for a first reasoning log (e.g., the reasoning log 255-a or the reasoning log 255-b) and the triggering event for the AI agent 210 to obtain the first reasoning log may be associated with the request. In some examples, the AI agent 215-a, the AI agent 215-b, or both may also output a respective reasoning log 255 based on a trigger associated with deviation detection. For example, the AI agent 215-a, the AI agent 215-b, or both may determine that the execution of the sub-task has started to deviate from the overall goal condition which may trigger the AI agent 215-a, the AI agent 215-b, or both, to output a respective reasoning log 255 to have the AI agent 210 perform some course or reasoning correction. Additionally, or alternatively, a trigger for outputting a respective reasoning log 255 may be associated with a resource conflict. For example, the AI agent 215-a may determine that the AI agent 215-a has to access a first resource of a set of resources and the AI agent 215-b is already accessing the first resource such that the AI agent 215-a and the AI agent 215-b would be attempting to access the same resource at the same time. In such cases, to prevent race conditions from occurring where behavior of a system depends on the relative timing or ordering of operations that can potentially lead to unpredictable outcomes when those operations execute in an unintended sequence, the AI agent 215-a, the AI agent 215-b, or both may be triggered to output a respective reasoning log 255 to the AI agent 210 to determine the order that the AI agent 215-a and the AI agent 215-b should access a resource.

Once a reasoning log 255 is generated, in response or based on a triggering event, a respective AI agent 215 may utilize a sharing module 260 (e.g., a sharing module 260-a for the AI agent 215-a and a sharing module 260-b for the AI agent 215-b) to share the reasoning log 255 with the AI agent 210. For example, after a triggering event, the AI agent 215-a may generate the reasoning log 255-a via utilization of the reasoning engine 250-a and then use the sharing module 260-a to output the reasoning log 255-a to the AI agent 210. In response, the AI agent 210 may obtain the reasoning log 255-a that can indicate a report associated with the execution of a first sub-task by the reasoning log 255-a. In some examples, the reasoning log 255-a may include information in accordance with a detail level of a set of detail levels based on an inter-agent reporting configuration. In some cases, the detail level of a respective reasoning log 255 may be associated with a connection between the AI agent 210 and a respective AI agent 215.

In some examples, the inter-agent reporting configuration may indicate one or more instructions for generating a report (e.g., a reasoning log 255) in accordance with a respective detail level based on one or more capabilities of the respective AI agent 215, one or more capabilities of respective AI agent 215, a configuration of the AI agent 210, a configuration of the respective AI agent 215, a relationship between the AI agent 210 and the respective AI agent 215, or any combination thereof. For example, the AI agent 210 and the AI agent 215-a may be related based on being configured by or for the same organization. Additionally, or alternatively, the relationship between the AI agent 210 and a respective AI agent 215 may indicate that the AI agent 210 and the respective AI agent 215 are unrelated and information sharing should be limited. The amount of information that is shared between a AI agent 215 and the AI agent 210 may be referred to as a detail level or an abstraction level. A detail level of a report or reasoning log 255 may indicate a level of information that is shared between agents and how the information is shared. In some examples, the detail level of the reasoning log 255 may ensure that the AI agent 210 is not overwhelmed with information. For example, if the AI agent 210 is unable to obtain (e.g., receive) relatively large reports (e.g., reasoning logs 255), a respective AI agent 215 may determine to utilize a detail level where only partial information or summaries of information are shared. In some cases, a set of information included in a report or reasoning log 255 may include sensitive information (e.g., personal identifiable information, confidential information, and the like). In such cases, a respective AI agent 215 may determine to include the sensitive information in the report, refrain from including the sensitive information, or determine to include the sensitive information as anonymized data, based on the detail level of the report, the inter-agent reporting configuration, or both. Therefore, a reasoning log 255 (e.g., the reasoning log 255-a, the reasoning log 255-b, or both) may include one or more data items that are anonymized, one or more sensitive data items, or both.

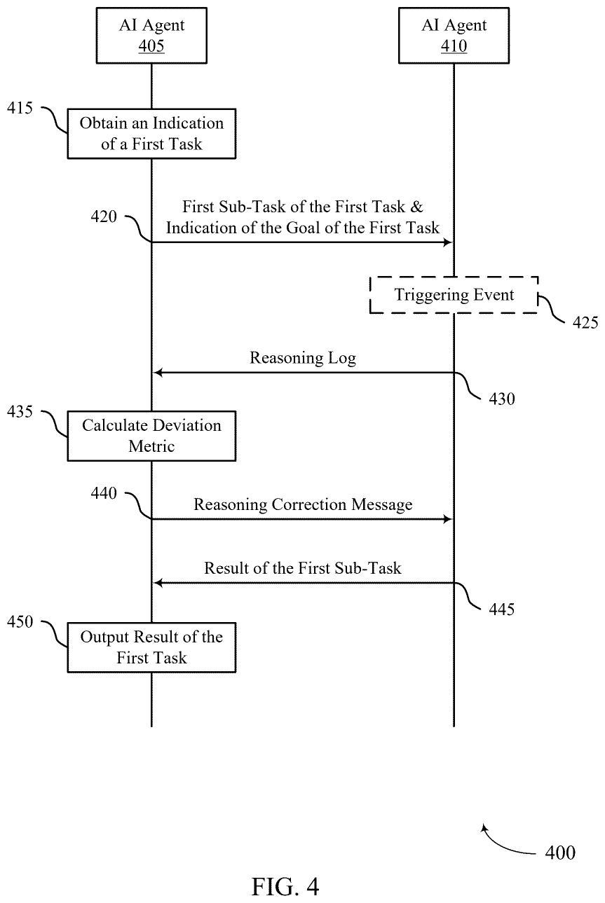

In some other examples, the inter-agent reporting configuration may indicate one or more triggering events for outputting a respective reasoning log 255. For example, the inter-agent reporting configuration may indicate that a respective reasoning log 255 will be reported subsequent to the execution of each intermediate step of the one or more intermediate steps, that a respective reasoning log 255 will be reported subsequent to an execution of a threshold of intermediate steps, or any combination thereof. Additionally, or alternatively, the AI agents 215 may share information with each other. For example, the AI agent 215-a may share the reasoning log 255-a or a report with the AI agent 215-b via the sharing module 260-a and the AI agent 215-b may share the reasoning log 255-b or a report with the AI agent 215-a via the sharing module 260-b. Further description of different detail levels that an AI agent 215 can use to share information with other AI agents 215 and the AI agent 210 may be described elsewhere herein, such as with reference to FIG. 4.

In response to obtaining a reasoning log 255 via the communications component 225, the AI agent 210 may parse the reasoning log 255 utilizing the reasoning analyzer 230 of the AI agent 210. The AI agent 210 may then utilize the feedback generator 235 to calculate a first deviation metric for at least one intermediate step of the one or more intermediate steps indicted via the reasoning log 255. The first deviation metric may quantify a reasoning deviation between the goal condition and the at least one intermediate step. To calculate the first deviation metric, the AI agent 210 may generate a first vector associated with the execution of the first sub-task based on the goal condition for the first task. Then, in response to obtaining a first reasoning log (e.g., the reasoning log 255-a or the reasoning log 255-b), the AI agent 210 may generate a second vector associated with one or more reasoning embeddings of the one or more intermediate steps taken by the respective AI agent 215 that output the first reasoning log. The AI agent 210 may then calculate a distance measurement between the first vector and the second vector and the reasoning deviation of the first deviation metric may be associated with the distance measurement. In other words, the AI agent 210 may identify inconsistencies, flawed assumptions, or other deviations from the overall plan or goal of a task based on reasonings being shared between the AI agent 215-a, the AI agent 215-b, or both and the AI agent 210 (e.g., based on the AI agent 210 obtaining the reasoning log 255).

Based on the first deviation metric exceeding a threshold (e.g., the distance measurement between the first vector and the second vector indicated via the reasoning deviation of the first deviation metric), the AI agent 210 may output a reasoning correction message that includes an indication of the at least one intermediate step associated with the first deviation metric. For example, based on determining that an intermediate step performed by the AI agent 215-a, the AI agent 215-b, or both deviate from the overall goal of a task and the deviation is above a threshold, the AI agent 210 may output (e.g., issue, send, transmit) corrective instructions to the AI agent 215-a, the AI agent 215-b, or both. In some examples, the corrective instructions may be generated by the feedback generator 235 of the AI agent 210. For example, based on the reasoning analyzer 230 analyzing the reasonings, the potential alternative intermediate steps, the resources utilized, or any combination thereof indicated via a respective reasoning log 255, the feedback generator 235 may generate the first deviation metric and work with the plan manager 240 to generate a corresponding reasoning correction message for the AI agent 215-a, the AI agent 215-b, or both.

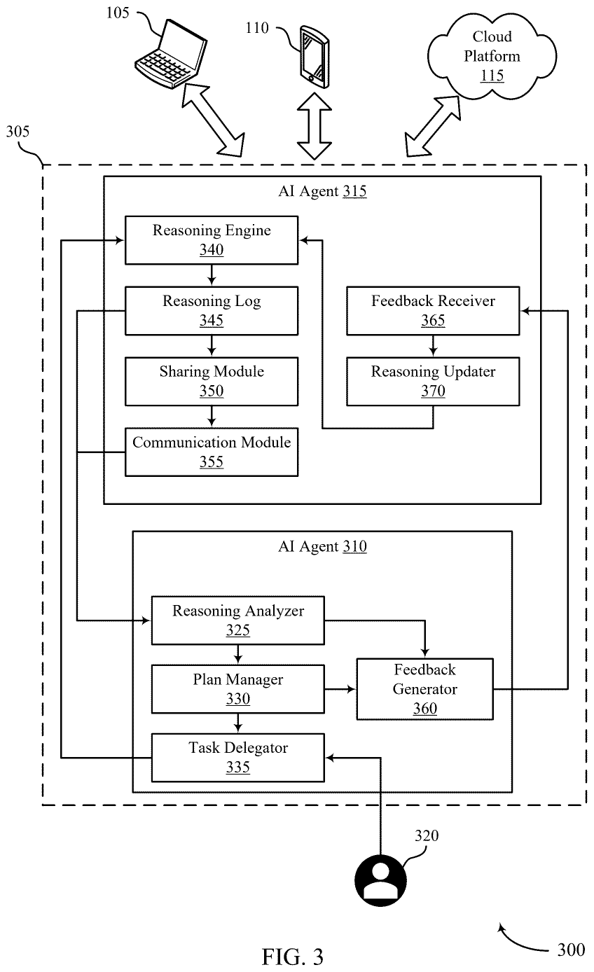

In some examples, the AI agent 210 may output the reasoning correction message to the AI agent 215-a, the AI agent 215-b, or both based on a respective deviation metric exceeding the threshold that is based on the distance measurement associated with the first deviation metric exceeding a threshold distance measurement. Further, when outputting the reasoning correction message, the AI agent 210 may output a set of additional grounding data for the AI agent 215-a, the AI agent 215-b, or both to add to a set of grounding data at the AI agent 215-a, the AI agent 215-b, or both. In some cases, the set of additional grounding data may include the indication of the at least one intermediate step that is associated with a respective deviation metric, an indication of one or more reasonings associated with the respective deviation metric exceeding the threshold, an indication of one or more alternative steps, or any combination thereof. Therefore, the AI agent 210 may be capable of dynamically adjusting the overall plan of a task and corresponding sub-tasks based on receiving indications of reasonings from the AI agent 215-a, the AI agent 215-b, or both. In response, the AI agent 215-a, the AI agent 215-b, or both may receive the corresponding feedback from the task delegator 245 of the AI agent 210 and adjust an execution of a respective sub-task accordingly. Further descriptions of the AI agent 215-a, the AI agent 215-b, or both adjusting a plan based on receiving feedback (e.g., a course correction message or a reasoning correction message) from the AI agent 210 may be described elsewhere herein, such as with reference to FIG. 3.

Moreover, based on the AI agent 215-a, the AI agent 215-b, or both completing the execution of corresponding sub-tasks, the AI agent 215-a, the AI agent 215-b, or both may output, to the AI agent 210, an indication of a result of the corresponding sub-tasks. For example, based on the AI agent 215-a completing the execution of a first sub-task, the AI agent 210 may obtain, from the AI agent 215-a, an indication of a result of the first sub-task. In response, the AI agent 210 may collect the results of each sub-task of a respective task, synthesize the results, and output an indication of a result of the respective task. For example, the AI agent 210 may collect the result of a sub-task from the AI agent 215-a and the AI agent 215-b and synthesize both sub-task results into a single result to output and report to the user 220, platform, or service that requested execution of a respective task by the multi-agent system 200. Further descriptions of such task execution process in accordance with the techniques of the present disclosure may be described elsewhere herein, such as with reference to FIGS. 3 through 5.

FIG. 3 shows an example of a multi-agent system 300 that supports AI agent reasoning sharing during inter-agent communications in accordance with aspects of the present disclosure. In some examples, the multi-agent system 300 may implement or be implemented by the system 100, the multi-agent system 200, or both. For example, the multi-agent system 300 may include a subsystem 305 that can be associated with one or more contacts 110, one or more cloud clients 105, and a cloud platform 115, which may represent examples of corresponding devices described herein with reference to FIG. 1. Further, the subsystem 305 may be hosted locally at a contact 110, a cloud client 105, or both, or can be hosted within the cloud platform 115. The subsystem 305 may include an AI agent 310 and one or more AI agents 315. In some examples, the subsystem 305 may illustrate the system where the AI agents 315 of the multi-agent system 300 are hosted, configured, utilized, or any combination thereof.

In some examples, the multi-agent system 300 may illustrate a subsystem 305 that includes an AI agent 310 and an AI agent 315 that are part of the multi-agent system 300. In some cases, the AI agent 310 may act as an orchestrator agent. An orchestrator agent may act as a central coordinator within the multi-agent system 300, managing and delegating tasks to ensure that various AI agents (e.g., the one or more AI agents 315) work together effectively to achieve a common goal. When the AI agent 310 functions as the orchestrator agent, the AI agent 310 may control the AI agent 315 by assigning respective sub-tasks and monitoring the progress of the AI agent 315. For example, the AI agent 310 may communicate with a user 320, other AI agents, platforms, or services, to receive queries that indicate tasks that the AI agent 310 may break down into one or more sub-tasks.

In some examples, an AI agent 310 may be configured with a reasoning analyzer 325, a plan manager 330, and a task delegator 335. In some cases, the AI agent 310 may obtain, from a user 320, an indication of a first task and utilize the task delegator 335 to break the first task down into one or more sub-tasks. The AI agent 310 may then output, to the AI agent 315 via the task delegator 335 of the AI agent 310, an indication of a first sub-task of the one or more sub-tasks of the first task. The AI agent 315 may then obtain the indication of the first sub-task via a reasoning engine 340 at the AI agent 315. Utilizing the reasoning engine 340, the AI agent 315 may begin to execute the first sub-task and generate a corresponding reasoning log 345. In some examples, the reasoning log 345 may be in a CoT format, a ToT format, or some other type of format indicating one or more intermediate steps performed by the AI agent 315, one or more alternative intermediate steps generated by the AI agent 315, or both along with corresponding reasonings.

Further, in response to a triggering event as described with reference to FIG. 2, the AI agent 315 may utilize a sharing module 350 and a communication module 355 to output the reasoning log 345 to the AI agent 310. For example, the communication module 355 may be configured to coordinate communications with other AI agents such as the AI agent 310. In some cases, the sharing module 350 may generate a report to share the reasoning log 345 such that the AI agent 315 shares the reasoning log 345 with the AI agent 310 at a detail or abstraction level that is in accordance with an inter-agent reporting configuration, as described with reference to FIG. 2 and further described elsewhere herein, such as with reference to FIGS. 3 and 4.

Moreover, the AI agent 310 may obtain the reasoning log 345 and utilize the reasoning analyzer 325 to parse and interpret the reasoning log 345 from the AI agent 315. Additionally, or alternatively, the AI agent 310 may utilize the reasoning analyzer 325 to identify one or more inconsistencies or deviations within the reasoning log 345. For example, the reasoning analyzer 325 may aid the AI agent 310 in determining if a deviation metric associated with at least one intermediate step of the reasoning log 345 exceeds a threshold. The AI agent 310 may then utilize the plan manager 330 to update a plan for the overall task. The AI agent 310 may further utilize a feedback generator 360 to generate a course correction message or a reasoning correction message for the AI agent 315. For example, the AI agent 310 may utilize the feedback generator 360 to generate corrective instructions for the AI agent 315.

The AI agent 315 may then receive the course correction message or a reasoning correction message from the feedback generator 360 of the AI agent 310 via a feedback receiver 365 at the AI agent 315. The AI agent 315 may utilize the feedback receiver 365 to obtain (e.g., receive) feedback indications (such as corrective instructions, course correction messages, reasoning correction messages, and the like) from the AI agent 310 that is acting as the orchestrator agent. The AI agent 315 may then utilize a reasoning updater 370 to determine how to correct the at least one intermediate step that is associate with the deviation metric exceeding the threshold. For example, the AI agent 315 may use the reasoning updater 370 to adjust which weights should be utilized by an AI/ML model (e.g., an LLM) associated with the AI agent 315. That is, in response to obtaining an indication that the AI agent 315 deviated from a goal of a task, the AI agent 315 may utilize the reasoning updater 370 to switch to using a set of weights (e.g., hyperparameters, parameter weights, or the like) that weight the initial instructions received from the AI agent 310 more heavily. Therefore, the AI agent 315 may utilize the reasoning updater 370 to update one or more reasonings and adjust plans based on feedback received from the AI agent 310 via the feedback receiver 365.

In some examples, such techniques of the present disclosure may ensure that the multi-agent system 300 is aligned with and in compliance with an explainable AI framework. Explainable AI may be an example of a framework that focuses on making the decision-making process of AI/ML models and agents relatively more transparent. For example, explainable AI techniques may be related to post-hoc explanations and the techniques of the present disclosure may improve such explanations by proactively integrating the sharing of decision making procedures between AI agents. In some other examples, the techniques of the present disclosure enable orchestrator agents to utilize shared reasonings (e.g., the reasoning log 345) to improve plan recognitions where plans and goals of an AI agent are inferred based on observed and historical actions. In some cases, the AI agent 310 and the AI agent 315 may also be belief-desire-intention (BDI) agents that have explicit representations of beliefs, desires, and intentions. In such cases, the techniques of the present disclosure may be an extension of BDI techniques and may enable improvements in making the reasoning processes behind intention formations more explicit. Therefore, the techniques of the present disclosure may improve the utilization of AI agents within the multi-agent system 300 and can increase the efficiency, reliability, and trust in the multi-agent system 300. For example, by ensuring that plans are adjusted prior to the completion of a sub-task, the techniques of the present disclosure may reduce the resource consumption associated with task executions via the multi-agent system 300 and by sharing reasonings between agents, trust from human users (e.g., the user 320) may improve accordingly.

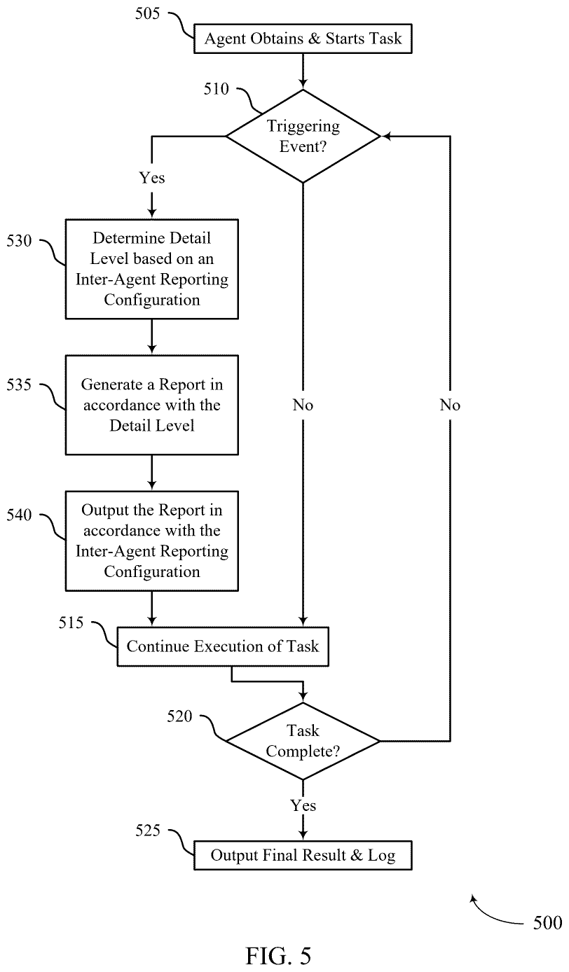

In some examples, the techniques of the present disclosure may improve the overall task performance of the multi-agent system 300. For example, early deviation detections and early correction of errors may lead to relatively higher success rates and more efficient task executions. The techniques of the present disclosure may also increase the robustness of the multi-agent system 300 by making the multi-agent system 300 relatively less susceptible to individual agent failures. Further, the multi-agent system 300 may have relatively enhanced agent collaboration and explainability in accordance with the techniques of the present disclosure due to the reasoning sharing. Moreover, since AI agents may share reasonings, the AI agents in the multi-agent system 300 may learn from each other which can accelerate an overall learning curve of the multi-agent system 300. Additionally, or alternatively, the techniques of the present disclosure may result in improved resource utilization based on to reductions on wasted efforts due to relatively early course and reasoning corrections. Further descriptions of the techniques of the present disclosure may be described elsewhere herein, such as with reference to FIGS. 4 and 5.

FIG. 4 shows an example of a process flow 400 that supports AI agent reasoning sharing during inter-agent communications in accordance with aspects of the present disclosure. In some examples, the process flow 400 may implement or be implemented by the system 100, the multi-agent system 200, the multi-agent system 300, or any combination thereof. For example, process flow 400 may include an AI agent 405 and an AI agent 410, which may be examples of devices described herein with reference to FIGS. 1-3 .

In the following description of the process flow 400, the operations between the AI agent 405 and the AI agent 410 may be performed in different orders or at different times. Some operations may also be left out of the process flow 400, or other operations may be added. Although the AI agent 405 and the AI agent 410 are shown performing the operations of the process flow 400, some aspects of some operations may also be performed by one or more other wireless devices.

At 415, an AI agent 405 may obtain an indication of a first task for completion by one or more AI agents of a multi-agent system (such as the AI agent 410). The first task may be associated with one or more sub-tasks and a goal condition. In some examples, the AI agent 405 may generate, in response to obtaining the indication of the first task, the one or more sub-tasks of the first task and the goal condition. In some other examples, the AI agent 405 may obtain, from an AI agent of the one or more AI agents in the multi-agent system (such as the AI agent 410), an indication of one or more capabilities of the AI agent, an indication of a configuration of the AI agent, or both. Additionally, or alternatively, the AI agent 405 may obtain the indication of the first task from a user via a user interface or from a third AI agent of the one or more AI agents of the multi-agent system.

At 420, the AI agent 405 may output, to an AI agent 410, a first message indicating a first sub-task of the one or more sub-tasks and an indication of the goal condition for the first task. That is, the AI agent 405 may delegate a sub-task to the AI agent 410. In some examples, the AI agent 405 may output the first message to the AI agent 410 based on obtaining the indication of the one or more capabilities of the AI agent 410, the indication of the configuration of the AI agent 410, or both, where the one or more capabilities of the AI agent 410, the configuration of the AI agent 410, or both indicate that the AI agent 410 may be capable of executing the first sub-task of the one or more sub-tasks. In response, the AI agent 410 may begin to execute the first sub-task and record reasonings within a first reasoning log utilizing a CoT format, a ToT format, or the like.

At 425, a triggering event may occur for obtaining the first reasoning log from the AI agent 410. In some examples, the triggering event for obtaining the first reasoning log may be based on an inter-agent reporting configuration of the AI agent 410, a request from the AI agent 405, a confidence score associated with a latest intermediate step of the one or more intermediate steps failing to satisfy a confidence score threshold, or any combination thereof. In some cases, the inter-agent reporting configuration of the AI agent 410 may indicate that a respective reasoning log may be reported subsequent to the execution of each intermediate step of the one or more intermediate steps, that a respective reasoning log may be reported subsequent to an execution of a threshold of intermediate steps, or any combination thereof. Further, the triggering event may be based on or associated with the AI agent 405 outputting, to the AI agent 410, a request for the first reasoning.

At 430, the AI agent 405 may obtain, from the AI agent 410 and based on a triggering event, a first reasoning log including one or more intermediate steps taken by the AI agent 410 associated with execution of the first sub-task. In some examples, the AI agent 405 may obtain, via the first reasoning log, an indication of one or more alternative intermediate steps, an indication of one or more reasonings for the one or more intermediate steps being taken by the AI agent 410, an indication of a confidence score for each of the one or more alternative intermediate steps, the one or more intermediate steps taken, or both, an indication of one or more sources associated with the one or more intermediate steps taken, or any combination thereof. Further, the one or more sources associated with the one or more intermediate steps taken by the AI agent 410 may include one or more databases, one or more application programming interfaces, one or more websites, one or more external data sources, or any combination thereof. In some cases, the first reasoning log may be associated with a detail level of a set of detail levels, the detail level of the first reasoning log being associated with a connection between the AI agent 405 and the AI agent 410. Additionally, or alternatively, the first reasoning log may include one or more data items that are anonymized, one or more sensitive data items, or both.

At 435, the AI agent 405 may calculate, from the first reasoning log, a first deviation metric for at least one intermediate step of the one or more intermediate steps, where the first deviation metric may quantify a reasoning deviation between the goal condition and the at least one intermediate step. That is, the AI agent 405 may analyze the reasonings of the AI agent 410 indicated via the first reasoning log. In some cases, such analysis may include comparing the reasonings in the first reasoning log to an overall plan and the reasonings of other AI agents. In some examples, calculating the first deviation metric may include generating a first vector associated with the execution of the first sub-task based on the goal condition for the first task and a second vector associated with one or more reasoning embeddings of the one or more intermediate steps taken by the AI agent 410. Moreover, the AI agent 405 may obtain (e.g., calculate) a distance measurement between the first vector and the second vector, where the reasoning deviation of the first deviation metric may be associated with the distance measurement.

At 440, the AI agent 405 may output, to the AI agent 410 and based on the first deviation metric exceeding a threshold, a reasoning correction message including an indication of the at least one intermediate step. For example, if the AI agent 405 (e.g., the orchestrator agent) detects a potential issue, such as the AI agent 410 following a path with relatively low probability of success, the AI agent 405 may output feedback to the AI agent 410 by sending a course correction message or a reasoning correction message. In some examples, outputting the reasoning correction message to the AI agent 410 based on the first deviation metric exceeding the threshold may be based on the distance measurement associated with the first deviation metric exceeding a threshold distance measurement. Further, the AI agent 405 may output a set of additional grounding data for the AI agent 410 to add to a set of grounding data at the AI agent 410, the set of additional grounding data including the indication of the at least one intermediate step that is associated with the first deviation metric, an indication of one or more reasonings associated with the first deviation metric exceeding the threshold, an indication of one or more alternative steps, or any combination thereof.

Based on obtaining the reasoning correction message, the AI agent 410 may perform one or more adjustments to integrate the feedback from the AI agent 405 indicated in the reasoning correction message and update the first reasoning log accordingly. The AI agent 405 and the AI agent 410 may then repeat the steps at 425, 430, 435, and 440 until the AI agent 410 completes the first sub-task. At 445, the AI agent 405 may obtain, from the AI agent 410, an indication of a result of the first sub-task. In some examples, the AI agent 405 may also obtain, from the AI agent 410, an indication of a completed reasoning log with the result of the first sub-task. At 450, the AI agent 405 may output an indication of a result of the first task based on obtaining the indication of the result to the first sub-task.

FIG. 5 shows an example of a flowchart 500 that supports AI agent reasoning sharing during inter-agent communications in accordance with aspects of the present disclosure. In some examples, the flowchart 500 may implement or be implemented by the system 100, the multi-agent system 200, the multi-agent system 300, or any combination thereof. For example, flowchart 500 may include steps or procedures executed by an AI agent or multiple different AI agents, which may be examples of devices described herein with reference to FIG. 1-3 (e.g., an AI agent that is associated with the generative AI component 145 described with reference to FIG. 1, an AI agent 210 or an AI agent 215 described with reference to FIG. 2, an AI agent 310 or an AI agent 315 described with reference to FIG. 3, or any combination thereof).

In the following description of the flowchart 500, the operations of an AI agent or multiple AI agents may be performed in different orders or at different times. Some operations may also be left out of the flowchart 500, or other operations may be added. Although the flowchart 500 may be described as an AI agent performing the operations of the flowchart 500, some aspects of some operations may also be performed by one or more other AI agents, devices, or services described elsewhere herein with reference to FIGS. 1-3.

At 505, a first AI agent may obtain, from a second AI agent, an indication of a first sub-task of a first task for execution by one or more AI agents of a multi-agent system. The first task may be associated with one or more sub-tasks and a goal condition. In response, the first AI agent may begin to execute the first sub-task in accordance with a set of instructions indicated via the indication of the first sub-task and in accordance with the goal condition.

At 510, the first AI agent may determine if a triggering event that initiates a report generation has occurred. In some examples, the triggering event may be based on a conclusion of a respective intermediate step of a set of intermediate steps associated with the execution of the first sub-task at the first AI agent, a confidence score associated with a respective intermediate step of the set of intermediate steps failing to satisfy a confidence score threshold, a request from the second AI agent, an indication of a first deviation metric, for at least one intermediate step of the set of intermediate steps, that quantifies a reasoning deviation between the goal condition and the at least one intermediate step, a resource conflict, or any combination thereof. In some cases, a resource conflict may be indicated based on the first AI agent attempting to access a resource at a same time as a respective AI agent of the one or more AI agents that is different from the first AI agent.

At 515, if the first AI agent determines that a triggering event has not occurred, the first AI agent may continue to execute the first sub-task. Then, at 520, the first AI agent may determine if the first sub-task is completed. If the first sub-task is completed, at 525, the first AI agent may output an indication of the result of the first sub-task to the second AI agent along with a report associated with the execution of the first sub-task at the first AI agent. Otherwise, if the first sub-task is not complete, the first AI agent may go back to 510 to determine if a triggering event has occurred during the execution of the first sub-task.

At 530, if the first AI agent determines that a triggering event has occurred, the first AI agent may determine a detail level for a report based on an inter-agent reporting configuration. In some examples, the inter-agent reporting configuration may indicate one or more instructions for generating the report in accordance with a respective detail level based on one or more capabilities of the first AI agent, one or more capabilities of the second AI agent, a configuration of the first AI agent, a configuration of the second AI agent, a relationship between the first AI agent and the second AI agent, or any combination thereof. In some examples, the first AI agent may determine that the detail level is associated with a summary, a full log (e.g., a full CoT log or a full ToT log), or a partial log (e.g., a partial CoT log or a partial ToT log).

At 535, the first AI agent may generate, based on a triggering event, a report associated with the execution of the first sub-task at the first AI agent. The report may include a detail level of a set of detail levels, where the detail level of the report may be based on an inter-agent reporting configuration. In some examples. the detail level of a report may also be referred to as an abstraction level and may indicate how much information and a level of detail for the information that should be shared between AI agents.

In some examples, generating the report may include generating, at the first AI agent, a summary associated with the execution of the first sub-task at the first AI agent and one or more reasonings corresponding to the summary, the report including the summary based on the detail level of the report, where the one or more instructions for generating the report in accordance with the detail level indicated via the inter-agent reporting configuration may include instructions for generation of the summary. In such examples, the detail level may indicate that the report should be generated to include a high-level overview of the intermediate steps and corresponding reasonings. In some cases, the first AI agent may use an AI/ML model (e.g., an LLM) to generate the summary indicated via the report. The AI/ML model may be the same AI/ML model associated with the first AI agent or a different AI/ML model.

In some other examples, generating the report may include selecting, at the first AI agent, a subset of information associated with the execution of the first sub-task at the first AI agent, the report including the subset of information and one or more reasonings for the subset of information based on selecting the subset of information, where selecting the subset of information may be based on the detail level of the report, and where the one or more instructions for generating the report in accordance with the detail level indicated via the inter-agent reporting configuration may include instructions for selecting the subset of information. For example, the first AI agent may determine to generate the report using a detail level associated with a partial CoT such that the report indicates a subset of the one or more intermediate steps performed by the first AI agent and refrains from indicating rejected hypotheses or alternative intermediate steps. That is, the first AI agent may refrain from selecting information for the subset of information that is associated with one or more intermediate steps rejected by the first AI agent during the execution of the first sub-task. Moreover, the first AI agent may determine to generate the report using a detail level associated with a partial ToT that indicates a respective branch or a subset of branches in a ToT log.

In another example, the report may include a set of information associated with the execution of the first sub-task at the first AI agent and one or more reasonings for the set of information based on the detail level of the report, and where the one or more instructions for generating the report in accordance with the detail level indicated via the inter-agent reporting configuration may include instructions for including the set of information in the report. For example, the report may indicate a full CoT log that indicates all the intermediate steps taken by the first AI agent or a full ToT log that indicates an entire ToT that includes all explored paths (e.g., the one or more alternative intermediate steps considered).

In some examples, the report may include information associated with a result of at least a portion of the execution of the first sub-task at the first AI agent, a result of the execution of the first sub-task at the first AI agent, or both. In some cases, the report may be a reasoning log including one or more intermediate steps taken by the first AI agent associated with the execution of the first sub-task. In some examples, a set of information included in the report may include sensitive information and the first AI agent may include the set of information in the report, the first AI agent may refrain from including the set of information in the report, or the first AI agent may include the set of information in the report as anonymized data, based on the detail level of the report, the inter-agent reporting configuration, or both.

At 540, the first AI agent may output, to the second AI agent, the report in accordance with the inter-agent reporting configuration. Then, the first AI agent may go to 515 to continue the execution of the first sub-task. Further, again at 520, the first AI agent determine if the execution of the first sub-task is complete. If not complete, the first AI agent may go back to 510 to determine if a triggering event has occurred during the continued execution of the first sub-task. If the first sub-task is complete, the first AI agent may output an indication of the result of the first sub-task to the second AI agent along with a report associated with the execution of the first sub-task at the first AI agent. In some examples, such report may be in accordance with a detail level that is indicated via the inter-agent reporting configuration. In some cases, the detail level may be the same detail level used for reporting during execution of the first sub-task at 540 or a different detail level.

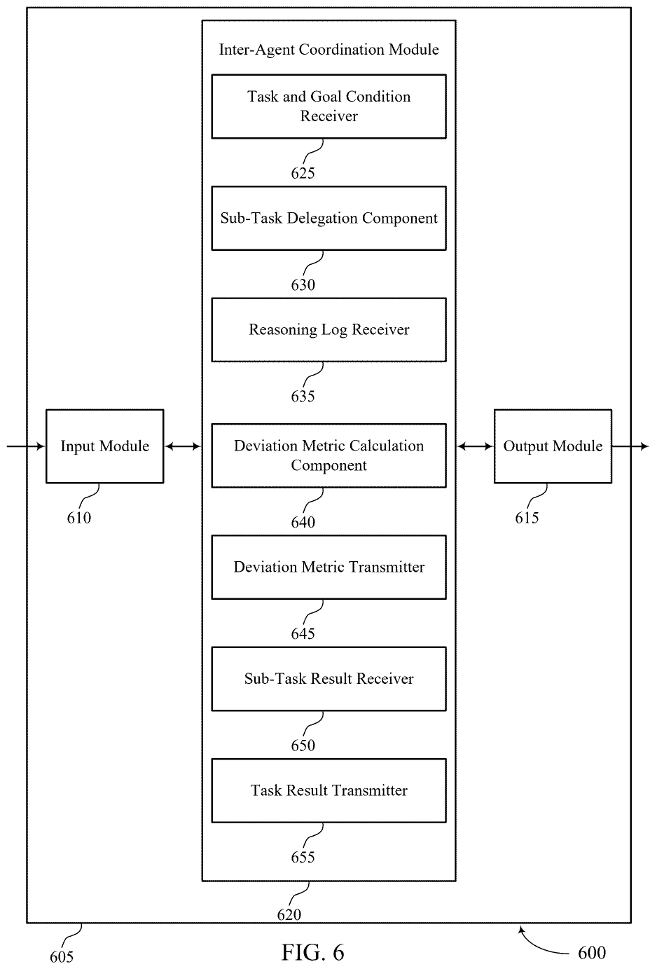

FIG. 6 shows a block diagram 600 of a device 605 that supports AI agent reasoning sharing during inter-agent communications in accordance with aspects of the present disclosure. The device 605 may include an input module 610, an output module 615, and an inter-agent coordination module 620. The device 605, or one or more components of the device 605 (e.g., the input module 610, the output module 615, the inter-agent coordination module 620), may include at least one processor, which may be coupled with at least one memory, to support the described techniques. Each of these components may be in communication with one another (e.g., via one or more buses).

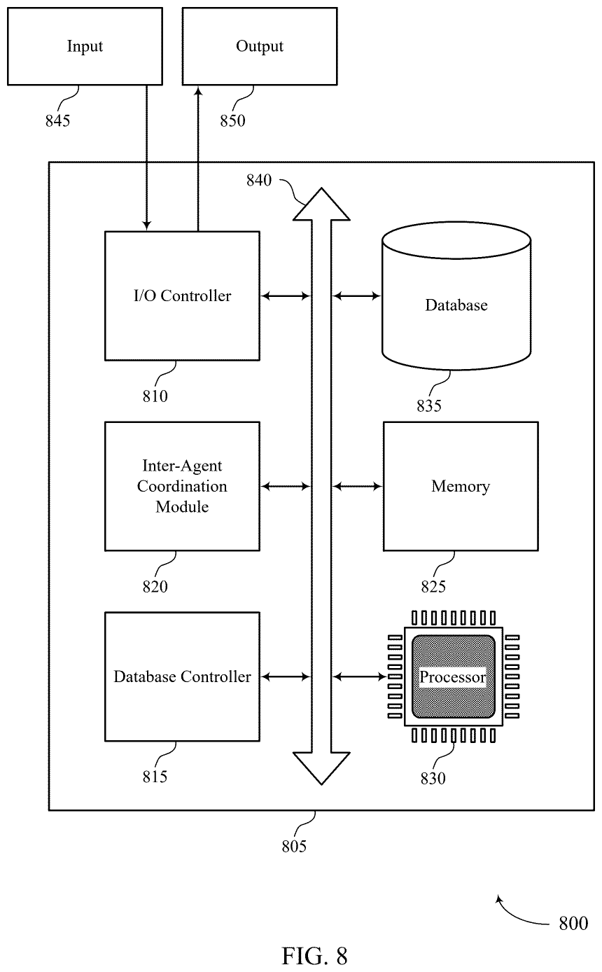

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the inter-agent coordination module 620 to support AI agent reasoning sharing during inter-agent communications. In some cases, the input module 610 may be a component of an input/output (I/O) controller 810 as described with reference to FIG. 8.

The output module 615 may manage output signals for the device 605. For example, the output module 615 may receive signals from other components of the device 605, such as the inter-agent coordination module 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the inter-agent coordination module 620 may include a task and goal condition receiver 625, a sub-task delegation component 630, a reasoning log receiver 635, a deviation metric calculation component 640, a reasoning correction message transmitter 645, a sub-task result receiver 650, a task result transmitter 655, or any combination thereof. In some examples, the inter-agent coordination module 620, or various components thereof, may be configured to perform various operations (e.g., receiving, monitoring, transmitting) using or otherwise in cooperation with the input module 610, the output module 615, or both. For example, the inter-agent coordination module 620 may receive information from the input module 610, send information to the output module 615, or be integrated in combination with the input module 610, the output module 615, or both to receive information, transmit information, or perform various other operations as described herein.

The inter-agent coordination module 620 may support inter-agent task execution in accordance with examples as disclosed herein. The task and goal condition receiver 625 may be configured to support obtaining, at a first AI agent, an indication of a first task for completion by one or more AI agents of a multi-agent system, where the first task is associated with one or more sub-tasks and a goal condition. The sub-task delegation component 630 may be configured to support outputting, to a second AI agent, a first message indicating a first sub-task of the one or more sub-tasks and an indication of the goal condition for the first task. The reasoning log receiver 635 may be configured to support obtaining, from the second AI agent and based on a triggering event, a first reasoning log including one or more intermediate steps taken by the second AI agent associated with execution of the first sub-task. The deviation metric calculation component 640 may be configured to support calculating, from the first reasoning log, a first deviation metric for at least one intermediate step of the one or more intermediate steps, where the first deviation metric quantifies a reasoning deviation between the goal condition and the at least one intermediate step. The reasoning correction message transmitter 645 may be configured to support outputting, to the second AI agent based on the first deviation metric exceeding a threshold, a reasoning correction message including an indication of the at least one intermediate step. The sub-task result receiver 650 may be configured to support obtaining, from the second AI agent, an indication of a result of the first sub-task. The task result transmitter 655 may be configured to support outputting an indication of a result of the first task based on obtaining the indication of the result to the first sub-task.

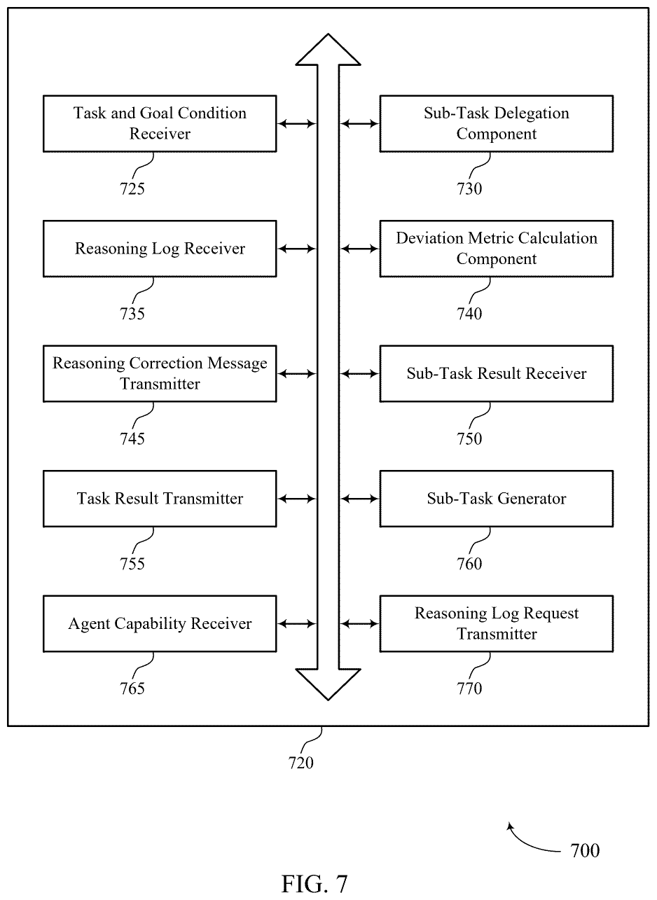

FIG. 7 shows a block diagram 700 of an inter-agent coordination module 720 that supports AI agent reasoning sharing during inter-agent communications in accordance with aspects of the present disclosure. The inter-agent coordination module 720 may be an example of aspects of an inter-agent coordination module or an inter-agent coordination module 620, or both, as described herein. The inter-agent coordination module 720, or various components thereof, may be an example of means for performing (e.g., to cause the inter-agent coordination module 720 to perform) various aspects of AI agent reasoning sharing during inter-agent communications as described herein. For example, the inter-agent coordination module 720 may include a task and goal condition receiver 725, a sub-task delegation component 730, a reasoning log receiver 735, a deviation metric calculation component 740, a reasoning correction message transmitter 745, a sub-task result receiver 750, a task result transmitter 755, a sub-task generator 760, an agent capability receiver 765, a reasoning log request transmitter 770, or any combination thereof. Each of these components, or components of subcomponents thereof (e.g., one or more processors, one or more memories), may communicate, directly or indirectly, with one another (e.g., via one or more buses).

The inter-agent coordination module 720 may support inter-agent task execution in accordance with examples as disclosed herein. The task and goal condition receiver 725 may be configured to support obtaining, at a first AI agent, an indication of a first task for completion by one or more AI agents of a multi-agent system, where the first task is associated with one or more sub-tasks and a goal condition. The sub-task delegation component 730 may be configured to support outputting, to a second AI agent, a first message indicating a first sub-task of the one or more sub-tasks and an indication of the goal condition for the first task. The reasoning log receiver 735 may be configured to support obtaining, from the second AI agent and based on a triggering event, a first reasoning log including one or more intermediate steps taken by the second AI agent associated with execution of the first sub-task. The deviation metric calculation component 740 may be configured to support calculating, from the first reasoning log, a first deviation metric for at least one intermediate step of the one or more intermediate steps, where the first deviation metric quantifies a reasoning deviation between the goal condition and the at least one intermediate step. The reasoning correction message transmitter 745 may be configured to support outputting, to the second AI agent based on the first deviation metric exceeding a threshold, a reasoning correction message including an indication of the at least one intermediate step. The sub-task result receiver 750 may be configured to support obtaining, from the second AI agent, an indication of a result of the first sub-task. The task result transmitter 755 may be configured to support outputting an indication of a result of the first task based on obtaining the indication of the result to the first sub-task.

In some examples, the sub-task generator 760 may be configured to support generating, in response to obtaining the indication of the first task, the one or more sub-tasks of the first task and the goal condition, where the first message is output to the second AI agent based on generation of the one or more sub-tasks and the goal condition.

In some examples, the agent capability receiver 765 may be configured to support obtaining, from an AI agent of the one or more AI agents in the multi-agent system, an indication of one or more capabilities of the AI agent, an indication of a configuration of the AI agent, or both.

In some examples, to support outputting the first message, the sub-task delegation component 730 may be configured to support outputting the first message to the second AI agent based on obtaining the indication of the one or more capabilities of the second AI agent, the indication of the configuration of the second AI agent, or both, where the one or more capabilities of the second AI agent, the configuration of the second AI agent, or both indicate that the second AI agent is capable of executing the first sub-task of the one or more sub-tasks.

In some examples, the reasoning log request transmitter 770 may be configured to support outputting, to the second AI agent, a request for the first reasoning log, where the triggering event for obtaining the first reasoning log from the second AI agent is associated with the request.

In some examples, to support obtaining the indication of the first task, the task and goal condition receiver 725 may be configured to support obtaining the indication of the first task from a user via a user interface or from a third AI agent of the one or more AI agents of the multi-agent system.

In some examples, to support obtaining the first reasoning log, the reasoning log receiver 735 may be configured to support obtaining, via the first reasoning log, an indication of one or more alternative intermediate steps, an indication of one or more reasonings for the one or more intermediate steps being taken by the second AI agent, an indication of a confidence score for each of the one or more alternative intermediate steps, the one or more intermediate steps taken, or both, an indication of one or more sources associated with the one or more intermediate steps taken, or any combination thereof.

In some examples, the one or more sources associated with the one or more intermediate steps taken by the second AI agent include one or more databases, one or more application programming interfaces, one or more websites, one or more external data sources, or any combination thereof.

In some examples, to support calculating the first deviation metric, the deviation metric calculation component 740 may be configured to support generating a first vector associated with the execution of the first sub-task based on the goal condition for the first task. In some examples, to support calculating the first deviation metric, the deviation metric calculation component 740 may be configured to support generating, in response to obtaining the first reasoning log, a second vector associated with one or more reasoning embeddings of the one or more intermediate steps taken by the second AI agent. In some examples, to support calculating the first deviation metric, the deviation metric calculation component 740 may be configured to support obtaining a distance measurement between the first vector and the second vector, where the reasoning deviation of the first deviation metric is associated with the distance measurement.

In some examples, outputting the reasoning correction message to the second AI agent based on the first deviation metric exceeding the threshold is based on the distance measurement associated with the first deviation metric exceeding a threshold distance measurement.

In some examples, to support outputting the reasoning correction message, the reasoning correction message transmitter 745 may be configured to support outputting a set of additional grounding data for the second AI agent to add to a set of grounding data at the second AI agent, the set of additional grounding data including the indication of the at least one intermediate step that is associated with the first deviation metric, an indication of one or more reasonings associated with the first deviation metric exceeding the threshold, an indication of one or more alternative steps, or any combination thereof.

In some examples, the triggering event for obtaining the first reasoning log is based on an inter-agent reporting configuration of the second AI agent, a request from the first AI agent, a confidence score associated with a latest intermediate step of the one or more intermediate steps failing to satisfy a confidence score threshold, or any combination thereof.

In some examples, the inter-agent reporting configuration of the second AI agent indicates that a respective reasoning log will be reported subsequent to the execution of each intermediate step of the one or more intermediate steps, that a respective reasoning log will be reported subsequent to an execution of a threshold of intermediate steps, or any combination thereof.

In some examples, the first reasoning log is associated with a detail level of a set of multiple detail levels, the detail level of the first reasoning log being associated with a connection between the first AI agent and the second AI agent.

In some examples, the first reasoning log includes one or more data items that are anonymized, one or more sensitive data items, or both.

FIG. 8 shows a diagram of a system 800 including a device 805 that supports AI agent reasoning sharing during inter-agent communications in accordance with aspects of the present disclosure. The device 805 may be an example of or include components of a device 605 as described herein. The device 805 may include components for bi-directional data communications including components for transmitting and receiving communications, such as an inter-agent coordination module 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting AI agent reasoning sharing during inter-agent communications). The processor 830 may be an example of a single processor or multiple processors. For example, the device 805 may include one or more processors 830.

The inter-agent coordination module 820 may support inter-agent task execution in accordance with examples as disclosed herein. For example, the inter-agent coordination module 820 may be configured to support obtaining, at a first AI agent, an indication of a first task for completion by one or more AI agents of a multi-agent system, where the first task is associated with one or more sub-tasks and a goal condition. The inter-agent coordination module 820 may be configured to support outputting, to a second AI agent, a first message indicating a first sub-task of the one or more sub-tasks and an indication of the goal condition for the first task. The inter-agent coordination module 820 may be configured to support obtaining, from the second AI agent and based on a triggering event, a first reasoning log including one or more intermediate steps taken by the second AI agent associated with execution of the first sub-task. The inter-agent coordination module 820 may be configured to support calculating, from the first reasoning log, a first deviation metric for at least one intermediate step of the one or more intermediate steps, where the first deviation metric quantifies a reasoning deviation between the goal condition and the at least one intermediate step. The inter-agent coordination module 820 may be configured to support outputting, to the second AI agent based on the first deviation metric exceeding a threshold, a reasoning correction message including an indication of the at least one intermediate step. The inter-agent coordination module 820 may be configured to support obtaining, from the second AI agent, an indication of a result of the first sub-task. The inter-agent coordination module 820 may be configured to support outputting an indication of a result of the first task based on obtaining the indication of the result to the first sub-task.

By including or configuring the inter-agent coordination module 820 in accordance with examples as described herein, the device 805 may support techniques for enhancing inter-agent task execution by sharing task execution reports in accordance with inter-agent reporting configurations to support improved communication reliability, reduced latency, improved user experience related to reduced processing, reduced power consumption, more efficient utilization of communication resources, improved coordination between agents, improved utilization of processing capability.

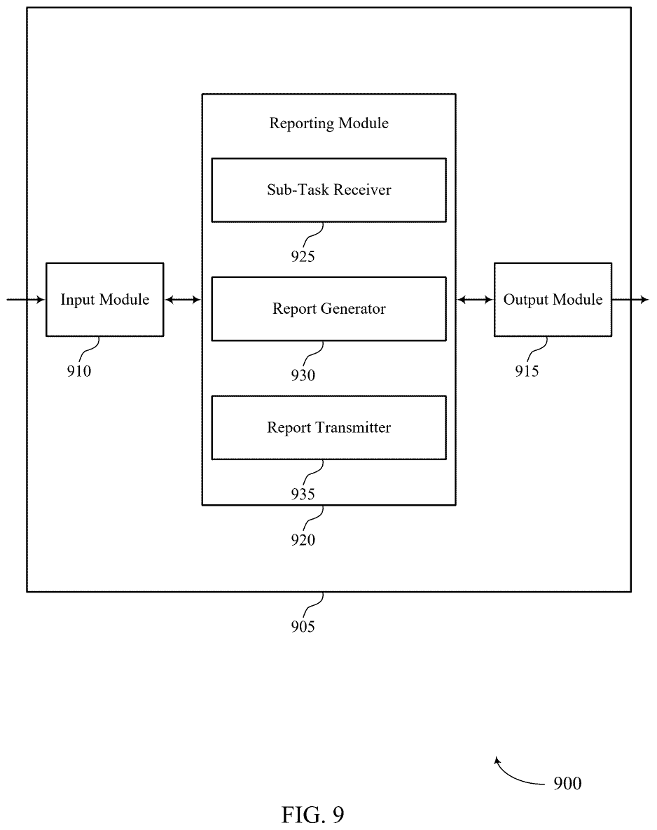

FIG. 9 shows a block diagram 900 of a device 905 that supports AI agent reasoning sharing during inter-agent communications in accordance with aspects of the present disclosure. The device 905 may include an input module 910, an output module 915, and a reporting module 920. The device 905, or one or more components of the device 905 (e.g., the input module 910, the output module 915, the reporting module 920), may include at least one processor, which may be coupled with at least one memory, to support the described techniques. Each of these components may be in communication with one another (e.g., via one or more buses).

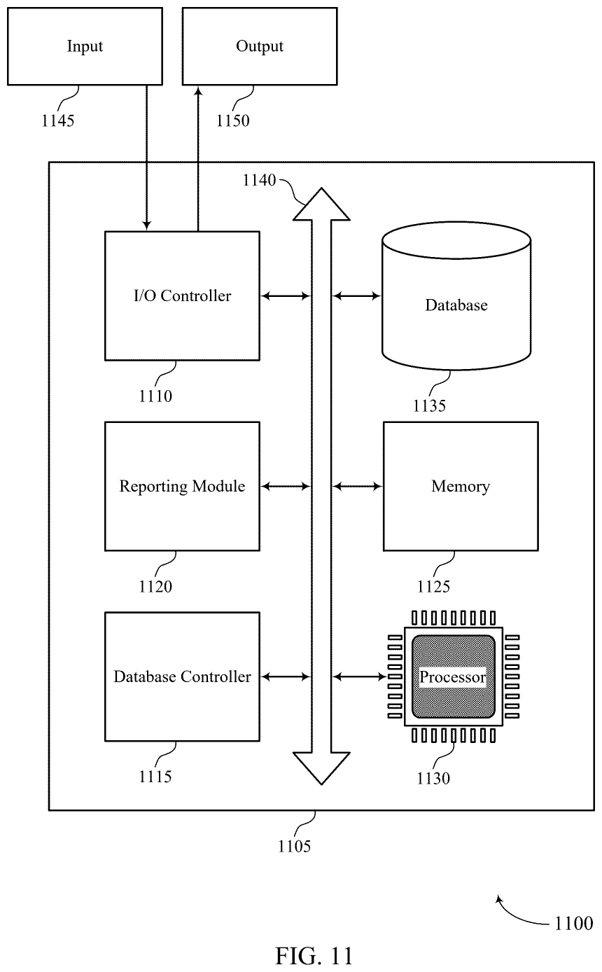

The input module 910 may manage input signals for the device 905. For example, the input module 910 may identify input signals based on an interaction with a modem, a keyboard, a mouse, a touchscreen, or a similar device. These input signals may be associated with user input or processing at other components or devices. In some cases, the input module 910 may utilize an operating system such as iOS®, ANDROID®, MS-DOS®, MS-WINDOWS®, OS/2®, UNIX®, LINUX®, or another known operating system to handle input signals. The input module 910 may send aspects of these input signals to other components of the device 905 for processing. For example, the input module 910 may transmit input signals to the reporting module 920 to support AI agent reasoning sharing during inter-agent communications. In some cases, the input module 910 may be a component of an input/output (I/O) controller 1110 as described with reference to FIG. 11.

The output module 915 may manage output signals for the device 905. For example, the output module 915 may receive signals from other components of the device 905, such as the reporting module 920, and may transmit these signals to other components or devices. In some examples, the output module 915 may transmit output signals for display in a user interface, for storage in a database or data store, for further processing at a server or server cluster, or for any other processes at any number of devices or systems. In some cases, the output module 915 may be a component of an I/O controller 1110 as described with reference to FIG. 11.

For example, the reporting module 920 may include a sub-task receiver 925, a report generator 930, a report transmitter 935, or any combination thereof. In some examples, the reporting module 920, or various components thereof, may be configured to perform various operations (e.g., receiving, monitoring, transmitting) using or otherwise in cooperation with the input module 910, the output module 915, or both. For example, the reporting module 920 may receive information from the input module 910, send information to the output module 915, or be integrated in combination with the input module 910, the output module 915, or both to receive information, transmit information, or perform various other operations as described herein.

The reporting module 920 may support inter-agent reporting between AI agents in accordance with examples as disclosed herein. The sub-task receiver 925 may be configured to support obtaining, at a first AI agent and from a second AI agent, an indication of a first sub-task of a first task for execution by one or more AI agents of a multi-agent system, where the first task is associated with one or more sub-tasks and a goal condition. The report generator 930 may be configured to support generating, based on a triggering event, a report associated with the execution of the first sub-task at the first AI agent, where the report includes a detail level of a set of multiple detail levels, where the detail level of the report is based on an inter-agent reporting configuration. The report transmitter 935 may be configured to support outputting, to the second AI agent, the report in accordance with the inter-agent reporting configuration.

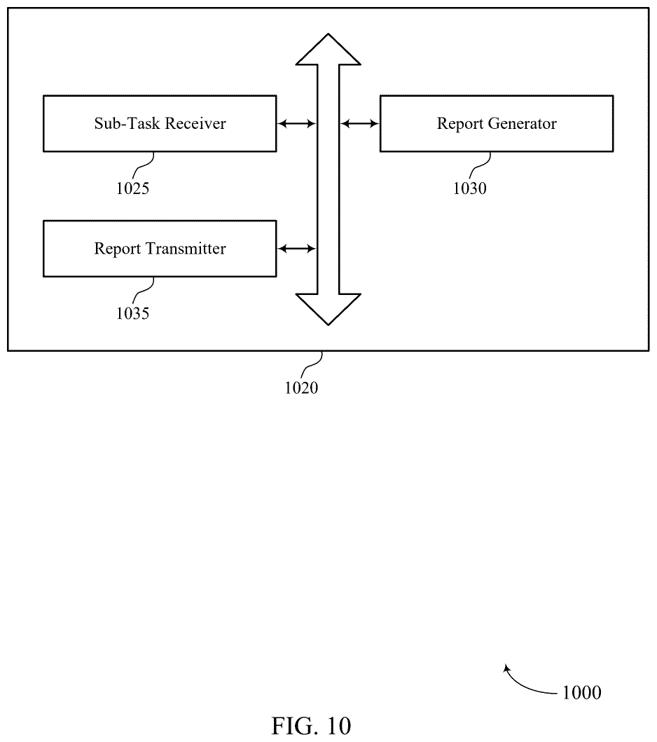

FIG. 10 shows a block diagram 1000 of a reporting module 1020 that supports AI agent reasoning sharing during inter-agent communications in accordance with aspects of the present disclosure. The reporting module 1020 may be an example of aspects of a reporting module or a reporting module 920, or both, as described herein. The reporting module 1020, or various components thereof, may be an example of means for performing (e.g., to cause the reporting module 1020 to perform) various aspects of AI agent reasoning sharing during inter-agent communications as described herein. For example, the reporting module 1020 may include a sub-task receiver 1025, a report generator 1030, a report transmitter 1035, or any combination thereof. Each of these components, or components of subcomponents thereof (e.g., one or more processors, one or more memories), may communicate, directly or indirectly, with one another (e.g., via one or more buses).

The reporting module 1020 may support inter-agent reporting between AI agents in accordance with examples as disclosed herein. The sub-task receiver 1025 may be configured to support obtaining, at a first AI agent and from a second AI agent, an indication of a first sub-task of a first task for execution by one or more AI agents of a multi-agent system, where the first task is associated with one or more sub-tasks and a goal condition. The report generator 1030 may be configured to support generating, based on a triggering event, a report associated with the execution of the first sub-task at the first AI agent, where the report includes a detail level of a set of multiple detail levels, where the detail level of the report is based on an inter-agent reporting configuration. The report transmitter 1035 may be configured to support outputting, to the second AI agent, the report in accordance with the inter-agent reporting configuration.

In some examples, the inter-agent reporting configuration indicates one or more instructions for generating the report in accordance with a respective detail level based on one or more capabilities of the first AI agent, one or more capabilities of the second AI agent, a configuration of the first AI agent, a configuration of the second AI agent, a relationship between the first AI agent and the second AI agent, or any combination thereof.

In some examples, to support generating the report, the report generator 1030 may be configured to support generating, at the first AI agent, a summary associated with the execution of the first sub-task at the first AI agent and one or more reasonings corresponding to the summary, the report including the summary based on the detail level of the report, where the one or more instructions for generating the report in accordance with the detail level indicated via the inter-agent reporting configuration includes instructions for generation of the summary.

In some examples, to support generating the report, the report generator 1030 may be configured to support selecting, at the first AI agent, a subset of information associated with the execution of the first sub-task at the first AI agent, the report including the subset of information and one or more reasonings for the subset of information based on selecting the subset of information, where selecting the subset of information is based on the detail level of the report, and where the one or more instructions for generating the report in accordance with the detail level indicated via the inter-agent reporting configuration includes instructions for selecting the subset of information.

In some examples, the first AI agent refrains from selecting information for the subset of information that is associated with one or more intermediate steps rejected by the first AI agent during the execution of the first sub-task.

In some examples, the report includes a set of information associated with the execution of the first sub-task at the first AI agent and one or more reasonings for the set of information based on the detail level of the report. In some examples, the one or more instructions for generating the report in accordance with the detail level indicated via the inter-agent reporting configuration includes instructions for including the set of information in the report.

In some examples, the triggering event is based on a conclusion of a respective intermediate step of a set of intermediate steps associated with the execution of the first sub-task at the first AI agent, a confidence score associated with a respective intermediate step of the set of intermediate steps failing to satisfy a confidence score threshold, a request from the second AI agent, an indication of a first deviation metric, for at least one intermediate step of the set of intermediate steps, that quantifies a reasoning deviation between the goal condition and the at least one intermediate step, a resource conflict, or any combination thereof.

In some examples, the resource conflict is indicated based on the first AI agent attempting to access a resource at a same time as a respective AI agent of the one or more AI agents that is different from the first AI agent.

In some examples, the report includes information associated with a result of at least a portion of the execution of the first sub-task at the first AI agent, a result of the execution of the first sub-task at the first AI agent, or both.

In some examples, the report is a reasoning log including one or more intermediate steps taken by the first AI agent associated with the execution of the first sub-task.

In some examples, a set of information included in the report includes sensitive information and the first AI agent includes the set of information in the report, the first AI agent refrains from including the set of information in the report, or the first AI agent includes the set of information in the report as anonymized data, based on the detail level of the report, the inter-agent reporting configuration, or both.

FIG. 11 shows a diagram of a system 1100 including a device 1105 that supports AI agent reasoning sharing during inter-agent communications in accordance with aspects of the present disclosure. The device 1105 may be an example of or include components of a device 905 as described herein. The device 1105 may include components for bi-directional data communications including components for transmitting and receiving communications, such as a reporting module 1120, an I/O controller, such as an I/O controller 1110, a database controller 1115, at least one memory 1125, at least one processor 1130, and a database 1135. These components may be in electronic communication or otherwise coupled (e.g., operatively, communicatively, functionally, electronically, electrically) via one or more buses (e.g., a bus 1140).

The I/O controller 1110 may manage input signals 1145 and output signals 1150 for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. In other cases, the I/O controller 1110 may represent or interact with a modem, a keyboard, a mouse, a touchscreen, or a similar device. In some cases, the I/O controller 1110 may be implemented as part of a processor 1130. In some examples, a user may interact with the device 1105 via the I/O controller 1110 or via hardware components controlled by the I/O controller 1110.

The database controller 1115 may manage data storage and processing in a database 1135. In some cases, a user may interact with the database controller 1115. In other cases, the database controller 1115 may operate automatically without user interaction. The database 1135 may be an example of a single database, a distributed database, multiple distributed databases, a data store, a data lake, or an emergency backup database.

Memory 1125 may include random-access memory (RAM) and read-only memory (ROM). The memory 1125 may store computer-readable, computer-executable software including instructions that, when executed, cause at least one processor 1130 to perform various functions described herein. In some cases, the memory 1125 may contain, among other things, a basic I/O system (BIOS) which may control basic hardware or software operation such as the interaction with peripheral components or devices. The memory 1125 may be an example of a single memory or multiple memories. For example, the device 1105 may include one or more memories 1125.

The processor 1130 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1130 may be configured to operate a memory array using a memory controller. In other cases, a memory controller may be integrated into the processor 1130. The processor 1130 may be configured to execute computer-readable instructions stored in at least one memory 1125 to perform various functions (e.g., functions or tasks supporting AI agent reasoning sharing during inter-agent communications). The processor 1130 may be an example of a single processor or multiple processors. For example, the device 1105 may include one or more processors 1130.

The reporting module 1120 may support inter-agent reporting between AI agents in accordance with examples as disclosed herein. For example, the reporting module 1120 may be configured to support obtaining, at a first AI agent and from a second AI agent, an indication of a first sub-task of a first task for execution by one or more AI agents of a multi-agent system, where the first task is associated with one or more sub-tasks and a goal condition. The reporting module 1120 may be configured to support generating, based on a triggering event, a report associated with the execution of the first sub-task at the first AI agent, where the report includes a detail level of a set of multiple detail levels, where the detail level of the report is based on an inter-agent reporting configuration. The reporting module 1120 may be configured to support outputting, to the second AI agent, the report in accordance with the inter-agent reporting configuration.

By including or configuring the reporting module 1120 in accordance with examples as described herein, the device 1105 may support techniques for enhancing inter-agent task execution by sharing task execution reports in accordance with inter-agent reporting configurations to support improved communication reliability, reduced latency, improved user experience related to reduced processing, reduced power consumption, more efficient utilization of communication resources, improved coordination between agents, improved utilization of processing capability.

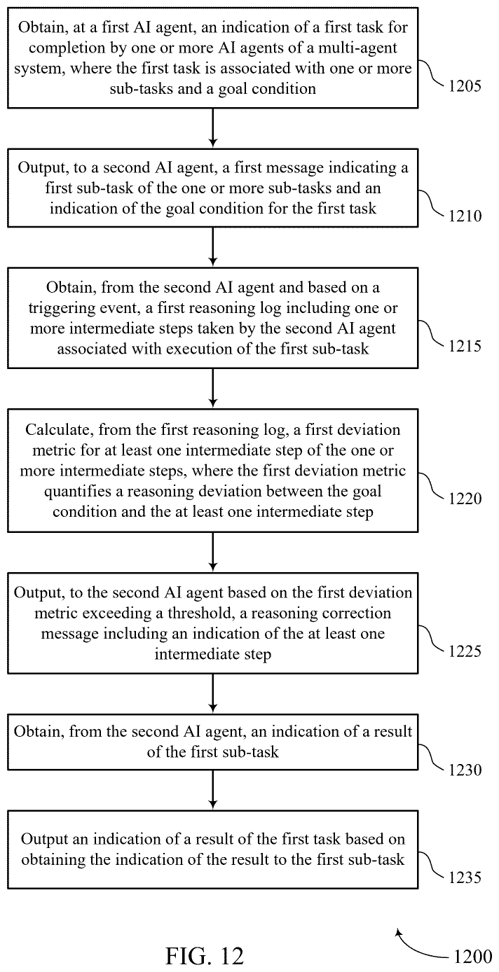

FIG. 12 shows a flowchart illustrating a method 1200 that supports AI agent reasoning sharing during inter-agent communications in accordance with aspects of the present disclosure. The operations of the method 1200 may be implemented by an AI agent of a multi-agent system or its components as described herein. For example, the operations of the method 1200 may be performed by an AI agent of a multi-agent system as described with reference to FIGS. 1 through 8. In some examples, an AI agent may execute a set of instructions to control the functional elements of the AI agent to perform the described functions. Additionally, or alternatively, the AI agent may perform aspects of the described functions using special-purpose hardware.

At 1205, the method may include obtaining, at a first AI agent, an indication of a first task for completion by one or more AI agents of a multi-agent system, where the first task is associated with one or more sub-tasks and a goal condition. The operations of 1205 may be performed in accordance with examples as disclosed herein. In some examples, aspects of the operations of 1205 may be performed by a task and goal condition receiver 725.

At 1210, the method may include outputting, to a second AI agent, a first message indicating a first sub-task of the one or more sub-tasks and an indication of the goal condition for the first task. The operations of 1210 may be performed in accordance with examples as disclosed herein. In some examples, aspects of the operations of 1210 may be performed by a sub-task delegation component 730.

At 1215, the method may include obtaining, from the second AI agent and based on a triggering event, a first reasoning log including one or more intermediate steps taken by the second AI agent associated with execution of the first sub-task. The operations of 1215 may be performed in accordance with examples as disclosed herein. In some examples, aspects of the operations of 1215 may be performed by a reasoning log receiver 735.

At 1220, the method may include calculating, from the first reasoning log, a first deviation metric for at least one intermediate step of the one or more intermediate steps, where the first deviation metric quantifies a reasoning deviation between the goal condition and the at least one intermediate step. The operations of 1220 may be performed in accordance with examples as disclosed herein. In some examples, aspects of the operations of 1220 may be performed by a deviation metric calculation component 740.

At 1225, the method may include outputting, to the second AI agent based on the first deviation metric exceeding a threshold, a reasoning correction message including an indication of the at least one intermediate step. The operations of 1225 may be performed in accordance with examples as disclosed herein. In some examples, aspects of the operations of 1225 may be performed by a reasoning correction message transmitter 745.

At 1230, the method may include obtaining, from the second AI agent, an indication of a result of the first sub-task. The operations of 1230 may be performed in accordance with examples as disclosed herein. In some examples, aspects of the operations of 1230 may be performed by a sub-task result receiver 750.

At 1235, the method may include outputting an indication of a result of the first task based on obtaining the indication of the result to the first sub-task. The operations of 1235 may be performed in accordance with examples as disclosed herein. In some examples, aspects of the operations of 1235 may be performed by a task result transmitter 755.

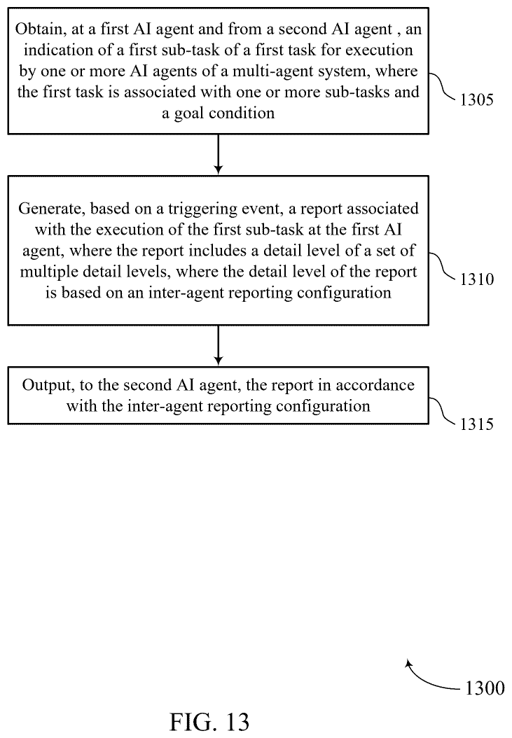

FIG. 13 shows a flowchart illustrating a method 1300 that supports AI agent reasoning sharing during inter-agent communications in accordance with aspects of the present disclosure. The operations of the method 1300 may be implemented by an AI agent of a multi-agent system or its components as described herein. For example, the operations of the method 1300 may be performed by an AI agent as described with reference to FIGS. 1 through 5 and 9 through 11. In some examples, an AI agent may execute a set of instructions to control the functional elements of the AI agent to perform the described functions. Additionally, or alternatively, the AI agent may perform aspects of the described functions using special-purpose hardware.

At 1305, the method may include obtaining, at a first AI agent and from a second AI agent, an indication of a first sub-task of a first task for execution by one or more AI agents of a multi-agent system, where the first task is associated with one or more sub-tasks and a goal condition. The operations of 1305 may be performed in accordance with examples as disclosed herein. In some examples, aspects of the operations of 1305 may be performed by a sub-task receiver 1025.

At 1310, the method may include generating, based on a triggering event, a report associated with the execution of the first sub-task at the first AI agent, where the report includes a detail level of a set of multiple detail levels, where the detail level of the report is based on an inter-agent reporting configuration. The operations of 1310 may be performed in accordance with examples as disclosed herein. In some examples, aspects of the operations of 1310 may be performed by a report generator 1030.

At 1315, the method may include outputting, to the second AI agent, the report in accordance with the inter-agent reporting configuration. The operations of 1315 may be performed in accordance with examples as disclosed herein. In some examples, aspects of the operations of 1315 may be performed by a report transmitter 1035.

A method for inter-agent task execution by one or more AI agents is described. The method may include obtaining, at a first AI agent, an indication of a first task for completion by one or more AI agents of a multi-agent system, where the first task is associated with one or more sub-tasks and a goal condition, outputting, to a second AI agent, a first message indicating a first sub-task of the one or more sub-tasks and an indication of the goal condition for the first task, obtaining, from the second AI agent and based on a triggering event, a first reasoning log including one or more intermediate steps taken by the second AI agent associated with execution of the first sub-task, calculating, from the first reasoning log, a first deviation metric for at least one intermediate step of the one or more intermediate steps, where the first deviation metric quantifies a reasoning deviation between the goal condition and the at least one intermediate step, outputting, to the second AI agent based on the first deviation metric exceeding a threshold, a reasoning correction message including an indication of the at least one intermediate step, obtaining, from the second AI agent, an indication of a result of the first sub-task, and outputting an indication of a result of the first task based on obtaining the indication of the result to the first sub-task.

An apparatus for inter-agent task execution is described. The AI agents may include one or more memories storing processor executable code, and one or more processors coupled with the one or more memories. The one or more processors may individually or collectively be operable to execute the code to cause the AI agents to obtain, at a first AI agent, an indication of a first task for completion by one or more AI agents of a multi-agent system, where the first task is associated with one or more sub-tasks and a goal condition, output, to a second AI agent, a first message indicating a first sub-task of the one or more sub-tasks and an indication of the goal condition for the first task, obtain, from the second AI agent and based on a triggering event, a first reasoning log including one or more intermediate steps taken by the second AI agent associated with execution of the first sub-task, calculate, from the first reasoning log, a first deviation metric for at least one intermediate step of the one or more intermediate steps, where the first deviation metric quantifies a reasoning deviation between the goal condition and the at least one intermediate step, output, to the second AI agent based on the first deviation metric exceeding a threshold, a reasoning correction message including an indication of the at least one intermediate step, obtain, from the second AI agent, an indication of a result of the first sub-task, and output an indication of a result of the first task based on obtaining the indication of the result to the first sub-task.

Another apparatus for inter-agent task execution is described. The AI agents may include means for obtaining, at a first AI agent, an indication of a first task for completion by one or more AI agents of a multi-agent system, where the first task is associated with one or more sub-tasks and a goal condition, means for outputting, to a second AI agent, a first message indicating a first sub-task of the one or more sub-tasks and an indication of the goal condition for the first task, means for obtaining, from the second AI agent and based on a triggering event, a first reasoning log including one or more intermediate steps taken by the second AI agent associated with execution of the first sub-task, means for calculating, from the first reasoning log, a first deviation metric for at least one intermediate step of the one or more intermediate steps, where the first deviation metric quantifies a reasoning deviation between the goal condition and the at least one intermediate step, means for outputting, to the second AI agent based on the first deviation metric exceeding a threshold, a reasoning correction message including an indication of the at least one intermediate step, means for obtaining, from the second AI agent, an indication of a result of the first sub-task, and means for outputting an indication of a result of the first task based on obtaining the indication of the result to the first sub-task.

A non-transitory computer-readable medium storing code for inter-agent task execution is described. The code may include instructions executable by one or more processors to obtain, at a first AI agent, an indication of a first task for completion by one or more AI agents of a multi-agent system, where the first task is associated with one or more sub-tasks and a goal condition, output, to a second AI agent, a first message indicating a first sub-task of the one or more sub-tasks and an indication of the goal condition for the first task, obtain, from the second AI agent and based on a triggering event, a first reasoning log including one or more intermediate steps taken by the second AI agent associated with execution of the first sub-task, calculate, from the first reasoning log, a first deviation metric for at least one intermediate step of the one or more intermediate steps, where the first deviation metric quantifies a reasoning deviation between the goal condition and the at least one intermediate step, output, to the second AI agent based on the first deviation metric exceeding a threshold, a reasoning correction message including an indication of the at least one intermediate step, obtain, from the second AI agent, an indication of a result of the first sub-task, and output an indication of a result of the first task based on obtaining the indication of the result to the first sub-task.

Some examples of the method, apparatus, and non-transitory computer-readable medium described herein may further include operations, features, means, or instructions for generating, in response to obtaining the indication of the first task, the one or more sub-tasks of the first task and the goal condition, where the first message may be output to the second AI agent based on generation of the one or more sub-tasks and the goal condition.

Some examples of the method, apparatus, and non-transitory computer-readable medium described herein may further include operations, features, means, or instructions for obtaining, from an AI agent of the one or more AI agents in the multi-agent system, an indication of one or more capabilities of the AI agent, an indication of a configuration of the AI agent, or both.

In some examples of the method, apparatus, and non-transitory computer-readable medium described herein, outputting the first message may include operations, features, means, or instructions for outputting the first message to the second AI agent based on obtaining the indication of the one or more capabilities of the second AI agent, the indication of the configuration of the second AI agent, or both, where the one or more capabilities of the second AI agent, the configuration of the second AI agent, or both indicate that the second AI agent may be capable of executing the first sub-task of the one or more sub-tasks.

Some examples of the method, apparatus, and non-transitory computer-readable medium described herein may further include operations, features, means, or instructions for outputting, to the second AI agent, a request for the first reasoning log, where the triggering event for obtaining the first reasoning log from the second AI agent may be associated with the request.

In some examples of the method, apparatus, and non-transitory computer-readable medium described herein, obtaining the indication of the first task may include operations, features, means, or instructions for obtaining the indication of the first task from a user via a user interface or from a third AI agent of the one or more AI agents of the multi-agent system.

In some examples of the method, apparatus, and non-transitory computer-readable medium described herein, obtaining the first reasoning log may include operations, features, means, or instructions for obtaining, via the first reasoning log, an indication of one or more alternative intermediate steps, an indication of one or more reasonings for the one or more intermediate steps being taken by the second AI agent, an indication of a confidence score for each of the one or more alternative intermediate steps, the one or more intermediate steps taken, or both, an indication of one or more sources associated with the one or more intermediate steps taken, or any combination thereof.

In some examples of the method, apparatus, and non-transitory computer-readable medium described herein, the one or more sources associated with the one or more intermediate steps taken by the second AI agent include one or more databases, one or more application programming interfaces, one or more websites, one or more external data sources, or any combination thereof.

In some examples of the method, apparatus, and non-transitory computer-readable medium described herein, calculating the first deviation metric may include operations, features, means, or instructions for generating a first vector associated with the execution of the first sub-task based on the goal condition for the first task, generating, in response to obtaining the first reasoning log, a second vector associated with one or more reasoning embeddings of the one or more intermediate steps taken by the second AI agent, and obtaining a distance measurement between the first vector and the second vector, where the reasoning deviation of the first deviation metric may be associated with the distance measurement.

Some examples of the method, apparatus, and non-transitory computer-readable medium described herein may further include operations, features, means, or instructions for outputting the reasoning correction message to the second AI agent based on the first deviation metric exceeding the threshold may be based on the distance measurement associated with the first deviation metric exceeding a threshold distance measurement.

In some examples of the method, apparatus, and non-transitory computer-readable medium described herein, outputting the reasoning correction message may include operations, features, means, or instructions for outputting a set of additional grounding data for the second AI agent to add to a set of grounding data at the second AI agent, the set of additional grounding data including the indication of the at least one intermediate step that may be associated with the first deviation metric, an indication of one or more reasonings associated with the first deviation metric exceeding the threshold, an indication of one or more alternative steps, or any combination thereof.

In some examples of the method, apparatus, and non-transitory computer-readable medium described herein, the triggering event for obtaining the first reasoning log may be based on an inter-agent reporting configuration of the second AI agent, a request from the first AI agent, a confidence score associated with a latest intermediate step of the one or more intermediate steps failing to satisfy a confidence score threshold, or any combination thereof.

In some examples of the method, apparatus, and non-transitory computer-readable medium described herein, the inter-agent reporting configuration of the second AI agent indicates that a respective reasoning log will be reported subsequent to the execution of each intermediate step of the one or more intermediate steps, that a respective reasoning log will be reported subsequent to an execution of a threshold of intermediate steps, or any combination thereof.

In some examples of the method, apparatus, and non-transitory computer-readable medium described herein, the first reasoning log may be associated with a detail level of a set of multiple detail levels, the detail level of the first reasoning log being associated with a connection between the first AI agent and the second AI agent.

In some examples of the method, apparatus, and non-transitory computer-readable medium described herein, the first reasoning log includes one or more data items that may be anonymized, one or more sensitive data items, or both.

A method for inter-agent reporting between AI agents by an apparatus is described. The method may include obtaining, at a first AI agent and from a second AI agent, an indication of a first sub-task of a first task for execution by one or more AI agents of a multi-agent system, where the first task is associated with one or more sub-tasks and a goal condition, generating, based on a triggering event, a report associated with the execution of the first sub-task at the first AI agent, where the report includes a detail level of a set of multiple detail levels, where the detail level of the report is based on an inter-agent reporting configuration, and outputting, to the second AI agent, the report in accordance with the inter-agent reporting configuration.

An apparatus for inter-agent reporting between AI agents is described. The apparatus may include one or more memories storing processor executable code, and one or more processors coupled with the one or more memories. The one or more processors may individually or collectively be operable to execute the code to cause the apparatus to obtain, at a first AI agent and from a second AI agent, an indication of a first sub-task of a first task for execution by one or more AI agents of a multi-agent system, where the first task is associated with one or more sub-tasks and a goal condition, generate, based on a triggering event, a report associated with the execution of the first sub-task at the first AI agent, where the report includes a detail level of a set of multiple detail levels, where the detail level of the report is based on an inter-agent reporting configuration, and output, to the second AI agent, the report in accordance with the inter-agent reporting configuration.

Another apparatus for inter-agent reporting between AI agents is described. The apparatus may include means for obtaining, at a first AI agent and from a second AI agent, an indication of a first sub-task of a first task for execution by one or more AI agents of a multi-agent system, where the first task is associated with one or more sub-tasks and a goal condition, means for generating, based on a triggering event, a report associated with the execution of the first sub-task at the first AI agent, where the report includes a detail level of a set of multiple detail levels, where the detail level of the report is based on an inter-agent reporting configuration, and means for outputting, to the second AI agent, the report in accordance with the inter-agent reporting configuration.

A non-transitory computer-readable medium storing code for inter-agent reporting between AI agents is described. The code may include instructions executable by one or more processors to obtain, at a first AI agent and from a second AI agent, an indication of a first sub-task of a first task for execution by one or more AI agents of a multi-agent system, where the first task is associated with one or more sub-tasks and a goal condition, generate, based on a triggering event, a report associated with the execution of the first sub-task at the first AI agent, where the report includes a detail level of a set of multiple detail levels, where the detail level of the report is based on an inter-agent reporting configuration, and output, to the second AI agent, the report in accordance with the inter-agent reporting configuration.

In some examples of the method, apparatus, and non-transitory computer-readable medium described herein, the inter-agent reporting configuration indicates one or more instructions for generating the report in accordance with a respective detail level based on one or more capabilities of the first AI agent, one or more capabilities of the second AI agent, a configuration of the first AI agent, a configuration of the second AI agent, a relationship between the first AI agent and the second AI agent, or any combination thereof.

In some examples of the method, apparatus, and non-transitory computer-readable medium described herein, generating the report may include operations, features, means, or instructions for generating, at the first AI agent, a summary associated with the execution of the first sub-task at the first AI agent and one or more reasonings corresponding to the summary, the report including the summary based on the detail level of the report, where the one or more instructions for generating the report in accordance with the detail level indicated via the inter-agent reporting configuration includes instructions for generation of the summary.

In some examples of the method, apparatus, and non-transitory computer-readable medium described herein, generating the report may include operations, features, means, or instructions for selecting, at the first AI agent, a subset of information associated with the execution of the first sub-task at the first AI agent, the report including the subset of information and one or more reasonings for the subset of information based on selecting the subset of information, where selecting the subset of information may be based on the detail level of the report, and where the one or more instructions for generating the report in accordance with the detail level indicated via the inter-agent reporting configuration includes instructions for selecting the subset of information.

In some examples of the method, apparatus, and non-transitory computer-readable medium described herein, the first AI agent refrains from selecting information for the subset of information that may be associated with one or more intermediate steps rejected by the first AI agent during the execution of the first sub-task.

In some examples of the method, apparatus, and non-transitory computer-readable medium described herein, the report includes a set of information associated with the execution of the first sub-task at the first AI agent and one or more reasonings for the set of information based on the detail level of the report and the one or more instructions for generating the report in accordance with the detail level indicated via the inter-agent reporting configuration includes instructions for including the set of information in the report.

In some examples of the method, apparatus, and non-transitory computer-readable medium described herein, the triggering event may be based on a conclusion of a respective intermediate step of a set of intermediate steps associated with the execution of the first sub-task at the first AI agent, a confidence score associated with a respective intermediate step of the set of intermediate steps failing to satisfy a confidence score threshold, a request from the second AI agent, an indication of a first deviation metric, for at least one intermediate step of the set of intermediate steps, that quantifies a reasoning deviation between the goal condition and the at least one intermediate step, a resource conflict, or any combination thereof.

In some examples of the method, apparatus, and non-transitory computer-readable medium described herein, the resource conflict may be indicated based on the first AI agent attempting to access a resource at a same time as a respective AI agent of the one or more AI agents that may be different from the first AI agent.

In some examples of the method, apparatus, and non-transitory computer-readable medium described herein, the report includes information associated with a result of at least a portion of the execution of the first sub-task at the first AI agent, a result of the execution of the first sub-task at the first AI agent, or both.

In some examples of the method, apparatus, and non-transitory computer-readable medium described herein, the report may be a reasoning log including one or more intermediate steps taken by the first AI agent associated with the execution of the first sub-task.

In some examples of the method, apparatus, and non-transitory computer-readable medium described herein, a set of information included in the report includes sensitive information and the first AI agent includes the set of information in the report, the first AI agent refrains from including the set of information in the report, or the first AI agent includes the set of information in the report as anonymized data, based on the detail level of the report, the inter-agent reporting configuration, or both.

The following provides an overview of aspects of the present disclosure:
Aspect 1: A method for inter-agent task execution by AI agents, comprising: obtaining, at a first AI agent, an indication of a first task for completion by one or more AI agents of a multi-agent system, wherein the first task is associated with one or more sub-tasks and a goal condition; outputting, to a second AI agent, a first message indicating a first sub-task of the one or more sub-tasks and an indication of the goal condition for the first task; obtaining, from the second AI agent and based at least in part on a triggering event, a first reasoning log comprising one or more intermediate steps taken by the second AI agent associated with execution of the first sub-task; calculating, from the first reasoning log, a first deviation metric for at least one intermediate step of the one or more intermediate steps, wherein the first deviation metric quantifies a reasoning deviation between the goal condition and the at least one intermediate step; outputting, to the second AI agent based at least in part on the first deviation metric exceeding a threshold, a reasoning correction message comprising an indication of the at least one intermediate step; obtaining, from the second AI agent, an indication of a result of the first sub-task; and outputting an indication of a result of the first task based at least in part on obtaining the indication of the result to the first sub-task.

Aspect 2: The method of aspect 1, further comprising: generating, in response to obtaining the indication of the first task, the one or more sub-tasks of the first task and the goal condition, wherein the first message is output to the second AI agent based at least in part on generation of the one or more sub-tasks and the goal condition.

Aspect 3: The method of any of aspects 1 through 2, further comprising: obtaining, from an AI agent of the one or more AI agents in the multi-agent system, an indication of one or more capabilities of the AI agent, an indication of a configuration of the AI agent, or both.

Aspect 4: The method of aspect 3, wherein outputting the first message comprises: outputting the first message to the second AI agent based at least in part on obtaining the indication of the one or more capabilities of the second AI agent, the indication of the configuration of the second AI agent, or both, wherein the one or more capabilities of the second AI agent, the configuration of the second AI agent, or both indicate that the second AI agent is capable of executing the first sub-task of the one or more sub-tasks.

Aspect 5: The method of any of aspects 1 through 4, further comprising: outputting, to the second AI agent, a request for the first reasoning log, wherein the triggering event for obtaining the first reasoning log from the second AI agent is associated with the request.

Aspect 6: The method of any of aspects 1 through 5, wherein obtaining the indication of the first task comprises: obtaining the indication of the first task from a user via a user interface or from a third AI agent of the one or more AI agents of the multi-agent system.

Aspect 7: The method of any of aspects 1 through 6, wherein obtaining the first reasoning log comprises: obtaining, via the first reasoning log, an indication of one or more alternative intermediate steps, an indication of one or more reasonings for the one or more intermediate steps being taken by the second AI agent, an indication of a confidence score for each of the one or more alternative intermediate steps, the one or more intermediate steps taken, or both, an indication of one or more sources associated with the one or more intermediate steps taken, or any combination thereof.

Aspect 8: The method of aspect 7, wherein the one or more sources associated with the one or more intermediate steps taken by the second AI agent comprise one or more databases, one or more application programming interfaces, one or more websites, one or more external data sources, or any combination thereof.

Aspect 9: The method of any of aspects 1 through 8, wherein calculating the first deviation metric comprises: generating a first vector associated with the execution of the first sub-task based at least in part on the goal condition for the first task; generating, in response to obtaining the first reasoning log, a second vector associated with one or more reasoning embeddings of the one or more intermediate steps taken by the second AI agent; and obtaining a distance measurement between the first vector and the second vector, wherein the reasoning deviation of the first deviation metric is associated with the distance measurement.

Aspect 10: The method of aspect 9, wherein outputting the reasoning correction message to the second AI agent based at least in part on the first deviation metric exceeding the threshold is based at least in part on the distance measurement associated with the first deviation metric exceeding a threshold distance measurement.

Aspect 11: The method of any of aspects 1 through 10, wherein outputting the reasoning correction message comprises: outputting a set of additional grounding data for the second AI agent to add to a set of grounding data at the second AI agent, the set of additional grounding data comprising the indication of the at least one intermediate step that is associated with the first deviation metric, an indication of one or more reasonings associated with the first deviation metric exceeding the threshold, an indication of one or more alternative steps, or any combination thereof.

Aspect 12: The method of any of aspects 1 through 11, wherein the triggering event for obtaining the first reasoning log is based at least in part on an inter-agent reporting configuration of the second AI agent, a request from the first AI agent, a confidence score associated with a latest intermediate step of the one or more intermediate steps failing to satisfy a confidence score threshold, or any combination thereof.

Aspect 13: The method of aspect 12, wherein the inter-agent reporting configuration of the second AI agent indicates that a respective reasoning log will be reported subsequent to the execution of each intermediate step of the one or more intermediate steps, that a respective reasoning log will be reported subsequent to an execution of a threshold of intermediate steps, or any combination thereof.

Aspect 14: The method of any of aspects 1 through 13, wherein the first reasoning log is associated with a detail level of a plurality of detail levels, the detail level of the first reasoning log being associated with a connection between the first AI agent and the second AI agent.

Aspect 15: The method of any of aspects 1 through 14, wherein the first reasoning log comprises one or more data items that are anonymized, one or more sensitive data items, or both.

Aspect 16: A method for inter-agent reporting between AI agents, comprising: obtaining, at a first AI agent and from a second AI agent, an indication of a first sub-task of a first task for execution by one or more AI agents of a multi-agent system, wherein the first task is associated with one or more sub-tasks and a goal condition; generating, based at least in part on a triggering event, a report associated with the execution of the first sub-task at the first AI agent, wherein the report comprises a detail level of a plurality of detail levels, wherein the detail level of the report is based at least in part on an inter-agent reporting configuration; and outputting, to the second AI agent, the report in accordance with the inter-agent reporting configuration.

Aspect 17: The method of aspect 16, wherein the inter-agent reporting configuration indicates one or more instructions for generating the report in accordance with a respective detail level based at least in part on one or more capabilities of the first AI agent, one or more capabilities of the second AI agent, a configuration of the first AI agent, a configuration of the second AI agent, a relationship between the first AI agent and the second AI agent, or any combination thereof.

Aspect 18: The method of aspect 17, wherein generating the report comprises: generating, at the first AI agent, a summary associated with the execution of the first sub-task at the first AI agent and one or more reasonings corresponding to the summary, the report comprising the summary based at least in part on the detail level of the report, wherein the one or more instructions for generating the report in accordance with the detail level indicated via the inter-agent reporting configuration comprises instructions for generation of the summary.

Aspect 19: The method of any of aspects 17 through 18, wherein generating the report comprises: selecting, at the first AI agent, a subset of information associated with the execution of the first sub-task at the first AI agent, the report comprising the subset of information and one or more reasonings for the subset of information based at least in part on selecting the subset of information, wherein selecting the subset of information is based at least in part on the detail level of the report, and wherein the one or more instructions for generating the report in accordance with the detail level indicated via the inter-agent reporting configuration comprises instructions for selecting the subset of information.

Aspect 20: The method of aspect 19, wherein the first AI agent refrains from selecting information for the subset of information that is associated with one or more intermediate steps rejected by the first AI agent during the execution of the first sub-task.

Aspect 21: The method of any of aspects 17 through 20, wherein the report comprises a set of information associated with the execution of the first sub-task at the first AI agent and one or more reasonings for the set of information based at least in part on the detail level of the report, and the one or more instructions for generating the report in accordance with the detail level indicated via the inter-agent reporting configuration comprises instructions for including the set of information in the report.

Aspect 22: The method of any of aspects 16 through 21, wherein the triggering event is based at least in part on a conclusion of a respective intermediate step of a set of intermediate steps associated with the execution of the first sub-task at the first AI agent, a confidence score associated with a respective intermediate step of the set of intermediate steps failing to satisfy a confidence score threshold, a request from the second AI agent, an indication of a first deviation metric, for at least one intermediate step of the set of intermediate steps, that quantifies a reasoning deviation between the goal condition and the at least one intermediate step, a resource conflict, or any combination thereof.

Aspect 23: The method of aspect 22, wherein the resource conflict is indicated based at least in part on the first AI agent attempting to access a resource at a same time as a respective AI agent of the one or more AI agents that is different from the first AI agent.

Aspect 24: The method of any of aspects 16 through 23, wherein the report includes information associated with a result of at least a portion of the execution of the first sub-task at the first AI agent, a result of the execution of the first sub-task at the first AI agent, or both.

Aspect 25: The method of any of aspects 16 through 24, wherein the report is a reasoning log comprising one or more intermediate steps taken by the first AI agent associated with the execution of the first sub-task.

Aspect 26: The method of any of aspects 16 through 25, wherein a set of information included in the report comprises sensitive information and the first AI agent includes the set of information in the report, the first AI agent refrains from including the set of information in the report, or the first AI agent includes the set of information in the report as anonymized data, based at least in part on the detail level of the report, the inter-agent reporting configuration, or both.

Aspect 27: An apparatus for inter-agent task execution, comprising one or more memories storing processor-executable code, and one or more processors coupled with the one or more memories and individually or collectively operable to execute the code to cause the AI agents to perform a method of any of aspects 1 through 15.

Aspect 28: An apparatus for inter-agent task execution, comprising at least one means for performing a method of any of aspects 1 through 15.

Aspect 29: A non-transitory computer-readable medium storing code for inter-agent task execution, the code comprising instructions executable by one or more processors to perform a method of any of aspects 1 through 15.

Aspect 30: An apparatus for inter-agent reporting between AI agents, comprising one or more memories storing processor-executable code, and one or more processors coupled with the one or more memories and individually or collectively operable to execute the code to cause the apparatus to perform a method of any of aspects 16 through 26.

Aspect 31: An apparatus for inter-agent reporting between AI agents, comprising at least one means for performing a method of any of aspects 16 through 26.

Aspect 32: A non-transitory computer-readable medium storing code for inter-agent reporting between AI agents, the code comprising instructions executable by one or more processors to perform a method of any of aspects 16 through 26.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for inter-agent task execution by artificial intelligence (AI) agents, comprising:
obtaining, at a first AI agent, an indication of a first task for completion by one or more AI agents of a multi-agent system, wherein the first task is associated with one or more sub-tasks and a goal condition;
outputting, to a second AI agent, a first message indicating a first sub-task of the one or more sub-tasks and an indication of the goal condition for the first task;
obtaining, from the second AI agent and based at least in part on a triggering event, a first reasoning log comprising one or more intermediate steps taken by the second AI agent associated with execution of the first sub-task;
calculating, from the first reasoning log, a first deviation metric for at least one intermediate step of the one or more intermediate steps, wherein the first deviation metric quantifies a reasoning deviation between the goal condition and the at least one intermediate step;
outputting, to the second AI agent based at least in part on the first deviation metric exceeding a threshold, a reasoning correction message comprising an indication of the at least one intermediate step;
obtaining, from the second AI agent, an indication of a result of the first sub-task; and
outputting an indication of a result of the first task based at least in part on obtaining the indication of the result to the first sub-task.

2. The method of claim 1, further comprising:
generating, in response to obtaining the indication of the first task, the one or more sub-tasks of the first task and the goal condition, wherein the first message is output to the second AI agent based at least in part on generation of the one or more sub-tasks and the goal condition.

3. The method of claim 1, further comprising:
obtaining, from an AI agent of the one or more AI agents in the multi-agent system, an indication of one or more capabilities of the AI agent, an indication of a configuration of the AI agent, or both.

4. The method of claim 3, wherein outputting the first message comprises:
outputting the first message to the second AI agent based at least in part on obtaining the indication of the one or more capabilities of the second AI agent, the indication of the configuration of the second AI agent, or both, wherein the one or more capabilities of the second AI agent, the configuration of the second AI agent, or both indicate that the second AI agent is capable of executing the first sub-task of the one or more sub-tasks.

5. The method of claim 1, further comprising:
outputting, to the second AI agent, a request for the first reasoning log, wherein the triggering event for obtaining the first reasoning log from the second AI agent is associated with the request.

6. The method of claim 1, wherein obtaining the indication of the first task comprises:
obtaining the indication of the first task from a user via a user interface or from a third AI agent of the one or more AI agents of the multi-agent system.

7. The method of claim 1, wherein obtaining the first reasoning log comprises:
obtaining, via the first reasoning log, an indication of one or more alternative intermediate steps, an indication of one or more reasonings for the one or more intermediate steps being taken by the second AI agent, an indication of a confidence score for each of the one or more alternative intermediate steps, the one or more intermediate steps taken, or both, an indication of one or more sources associated with the one or more intermediate steps taken, or any combination thereof.

8. The method of claim 7, wherein the one or more sources associated with the one or more intermediate steps taken by the second AI agent comprise one or more databases, one or more application programming interfaces, one or more websites, one or more external data sources, or any combination thereof.

9. The method of claim 1, wherein calculating the first deviation metric comprises:
generating a first vector associated with the execution of the first sub-task based at least in part on the goal condition for the first task;
generating, in response to obtaining the first reasoning log, a second vector associated with one or more reasoning embeddings of the one or more intermediate steps taken by the second AI agent; and
obtaining a distance measurement between the first vector and the second vector, wherein the reasoning deviation of the first deviation metric is associated with the distance measurement.

10. The method of claim 9, wherein outputting the reasoning correction message to the second AI agent based at least in part on the first deviation metric exceeding the threshold is based at least in part on the distance measurement associated with the first deviation metric exceeding a threshold distance measurement.

11. The method of claim 1, wherein outputting the reasoning correction message comprises:
outputting a set of additional grounding data for the second AI agent to add to a set of grounding data at the second AI agent, the set of additional grounding data comprising the indication of the at least one intermediate step that is associated with the first deviation metric, an indication of one or more reasonings associated with the first deviation metric exceeding the threshold, an indication of one or more alternative steps, or any combination thereof.

12. The method of claim 1, wherein the triggering event for obtaining the first reasoning log is based at least in part on an inter-agent reporting configuration of the second AI agent, a request from the first AI agent, a confidence score associated with a latest intermediate step of the one or more intermediate steps failing to satisfy a confidence score threshold, or any combination thereof.

13. The method of claim 12, wherein the inter-agent reporting configuration of the second AI agent indicates that a respective reasoning log will be reported subsequent to the execution of each intermediate step of the one or more intermediate steps, that a respective reasoning log will be reported subsequent to an execution of a threshold of intermediate steps, or any combination thereof.

14. The method of claim 1, wherein the first reasoning log is associated with a detail level of a plurality of detail levels, the detail level of the first reasoning log being associated with a connection between the first AI agent and the second AI agent.

15. The method of claim 1, wherein the first reasoning log comprises one or more data items that are anonymized, one or more sensitive data items, or both.

16. Artificial intelligence (AI) agents for inter-agent task execution, comprising:
one or more memories storing processor-executable code; and
one or more processors coupled with the one or more memories and individually or collectively operable to execute the code to cause the AI agents to:
obtain, at a first AI agent, an indication of a first task for completion by one or more AI agents of a multi-agent system, wherein the first task is associated with one or more sub-tasks and a goal condition;
output, to a second AI agent, a first message indicating a first sub-task of the one or more sub-tasks and an indication of the goal condition for the first task;
obtain, from the second AI agent and based at least in part on a triggering event, a first reasoning log comprising one or more intermediate steps taken by the second AI agent associated with execution of the first sub-task;
calculate, from the first reasoning log, a first deviation metric for at least one intermediate step of the one or more intermediate steps, wherein the first deviation metric quantifies a reasoning deviation between the goal condition and the at least one intermediate step;
output, to the second AI agent based at least in part on the first deviation metric exceeding a threshold, a reasoning correction message comprising an indication of the at least one intermediate step;
obtain, from the second AI agent, an indication of a result of the first sub-task; and
output an indication of a result of the first task based at least in part on obtaining the indication of the result to the first sub-task.

17. The AI agents of claim 16, wherein, to obtain the first reasoning log, the one or more processors are individually or collectively operable to execute the code to cause the AI agents to:
obtain, via the first reasoning log, an indication of one or more alternative intermediate steps, an indication of one or more reasonings for the one or more intermediate steps being taken by the second AI agent, an indication of a confidence score for each of the one or more alternative intermediate steps, the one or more intermediate steps taken, or both, an indication of one or more sources associated with the one or more intermediate steps taken, or any combination thereof.

18. The AI agents of claim 16, wherein, to calculate the first deviation metric, the one or more processors are individually or collectively operable to execute the code to cause the AI agents to:
generate a first vector associated with the execution of the first sub-task based at least in part on the goal condition for the first task;
generate, in response to obtaining the first reasoning log, a second vector associated with one or more reasoning embeddings of the one or more intermediate steps taken by the second AI agent; and
obtain a distance measurement between the first vector and the second vector, wherein the reasoning deviation of the first deviation metric is associated with the distance measurement.

19. The AI agents of claim 16, wherein, to output the reasoning correction message, the one or more processors are individually or collectively operable to execute the code to cause the AI agents to:
output a set of additional grounding data for the second AI agent to add to a set of grounding data at the second AI agent, the set of additional grounding data comprising the indication of the at least one intermediate step that is associated with the first deviation metric, an indication of one or more reasonings associated with the first deviation metric exceeding the threshold, an indication of one or more alternative steps, or any combination thereof.

20. A non-transitory computer-readable medium storing code for inter-agent task execution, the code comprising instructions executable by one or more processors to:
obtain, at a first artificial intelligence (AI) agent, an indication of a first task for completion by one or more AI agents of a multi-agent system, wherein the first task is associated with one or more sub-tasks and a goal condition;
output, to a second AI agent, a first message indicating a first sub-task of the one or more sub-tasks and an indication of the goal condition for the first task;
obtain, from the second AI agent and based at least in part on a triggering event, a first reasoning log comprising one or more intermediate steps taken by the second AI agent associated with execution of the first sub-task;
calculate, from the first reasoning log, a first deviation metric for at least one intermediate step of the one or more intermediate steps, wherein the first deviation metric quantifies a reasoning deviation between the goal condition and the at least one intermediate step;
output, to the second AI agent based at least in part on the first deviation metric exceeding a threshold, a reasoning correction message comprising an indication of the at least one intermediate step;
obtain, from the second AI agent, an indication of a result of the first sub-task; and
output an indication of a result of the first task based at least in part on obtaining the indication of the result to the first sub-task.
